(19) United States
(12) Patent Application Publication
(10) Pub. No.: US 2025/0100669 A1
(43) Pub. Date: Mar. 27, 2025

(54) AIRCRAFT FUSELAGE WING ATTACHMENT CUTOUT CONFIGURATIONS INCORPORATING PERIMETER BOX BEAMS

(71) Applicant: ZSM HOLDINGS, INC., Dover, DE (US)

(72) Inventors: Blake Poe, Longmont, CO (US); Jason C. Bell, Frederick, CO (US)

(21) Appl. No.: 18/294,540

(22) PCT Filed: Dec. 16, 2021
(86) PCT No.: PCT/US2021/063800

§ 371 Date: Feb. 1, 2024

Related U.S. Application Data
(60) Provisional application No. 63/229,065, filed on Aug. 3, 2021.

(51) Int. Cl. B64C 1/20; B64C 1/06; B64C 1/22

(52) U.S. Cl. CPC B64C 1/20; B64C 1/064; B64C 1/22

(57) ABSTRACT

A fixed-wing cargo aircraft having a fuselage wing cutout supported by box beam longerons is disclosed. The fuselage contains a continuous interior cargo bay, and includes a forward portion, an aft portion, and a cutout defined by a plurality of structural elements configured to transfer a wing load to the fuselage, the structural elements including opposite starboard and port longeron beams each spanning a longitudinal length of the cutout. The starboard and port longeron beams have an enclosed box beam construction, which can include a plurality of panel sections, at least one of the plurality of panel sections comprising a skin panel of the fuselage. The cutout can have forward and aft frame beams each having an enclosed box beam construction that form a structural perimeter of the cutout with the starboard and port longeron beams.

### CROSS-REFERENCE TO RELATED APPLICATIONS

This application claims priority to and the benefit of U.S. Provisional Application Ser. No. 63/229,065, entitled “AIRCRAFT FUSELAGE WING ATTACHMENT CUTOUT CONFIGURATIONS INCORPORATING PERIMETER BOX BEAMS,” and filed Aug. 3, 2021, the contents of which is incorporated by reference herein in its entirety.

### FIELD

The present disclosure relates to fuselage designs for cargo aircraft, and more particularly to structural arrangements for coupling a wing to an upper fuselage using perimeter box beams.

### BACKGROUND

Renewable energy remains an increasingly important resource year-over-year. While there are many forms of renewable energy, wind energy has increased an average of about 19 percent annually since 2007. The increase in global demand in recent years for more wind energy has catalyzed drastic advances in wind turbine technology, including the development of larger, better-performing wind turbines. Better-performing wind turbines can at least sometimes mean larger turbines, as generally turbines with larger rotor diameters can capture more wind energy. As turbines continue to improve in performance and efficiency, more and more wind farm sites in previously undeveloped locations become viable both onshore and offshore. These sites may also be existing sites, where older turbines need replacement by better-performing, more efficient turbines, and new sites.

A limiting factor to allow for the revitalization of old sites and development of new sites is transporting the wind turbines, and related equipment, to the sites. Wind turbine blades are difficult to transport long distances due to the terrestrial limitations of existing air vehicles and roadway infrastructures. Onshore transportation has traditionally required truck or rail transportation on existing infrastructure. Both roads and railways are limited by height and width of tunnels and bridges. Road transport has additional complications of lane width, road curvature, and the need to pass through urban areas that may require additional permitting and logistics, among other complications. Offshore transportation by ship is equally, if not more so, limiting. For example, delivery of parts can be limited to how accessible the offshore location is by ship due to various barriers (e.g., sand bars, coral reefs) and the like in the water and surrounding areas, as well as the availability of ships capable of handling such large structures.

Whether onshore or offshore, the road vehicle or ship options for transporting such equipment has become more limited, particularly as the size of wind turbines increase. Delivery is thus limited by the availability of vehicles and ships capable of handling such large structures. The very long lengths of wind turbine blades (some are presently 90 meters long, 100 meters long, or even longer) make conventional transportation by train, truck, or ship very difficult and complicated. Unfortunately, the solution is not as simple as making transportation vehicles longer and/or larger. There are a variety of complications that present themselves as vehicles are made longer and/or larger, including but not limited to complications of: load balancing of the vehicle; load balancing the equipment being transported; load balancing the two with respect to each other; handling, maneuverability, and control of the vehicle; and other complications that would be apparent to those skilled in the art.

Further, whether onshore or offshore, delivery of parts can be slow and severely limited by the accessibility of the site. Whether the site being developed is old or new, the sites can often be remote, and thus not near suitable transportation infrastructure. The sites may be far away from suitable roads and rails (or other means by which cargo may be transported) to allow for easy delivery of cargo for use in building the turbines at the site and/or other equipment used in developing the site. New sites are often in areas without any existing transportation infrastructure at all, thus requiring new construction and special equipment. Ultimately, transportation logistics become cost prohibitive, resulting in a literal and figurative roadblock to further advancing the use of wind energy on a global scale.

Existing cargo aircraft, including the largest aircraft ever to fly, are not able to transport extremely largo cargo, even if that cargo is, in all dimensions, smaller than the aircraft itself. This limitation is often the result of cargo aircraft, even those purpose built to be cargo aircraft, not fully utilizing their overall size as cargo bay volume. This constraint has many causes, one of which is related the need for large cargo aircraft to have large main wing assemblies, which itself necessitate a correspondingly substantial structural interface between the wing and the fuselage. This fuselage-wing interface can negatively impact the overall cargo volume available and/or the aircraft aerodynamics surrounding the wing-fuselage interface.

Accordingly, there is a need for large, transport-category aircraft wing-fuselage interface designs that minimally impact available cargo volume inside the aircraft.

### SUMMARY

Certain examples of the present disclosure include upper wing-to-fuselage interface designs for increasing the useable interior cargo bay of a cargo aircraft. Examples of the present disclosure include extremely large cargo aircraft capable of both carrying extremely long payloads and being able to take off and land at runways that are significantly shorter than those required by most, if not all, existing large aircraft. For purposes of the present disclosure, a large or long aircraft is considered an aircraft having a fuselage length from fuselage nose tip to fuselage tail tip that is at least approximately 60 meters long. The American Federal Aviation Administration (FAA) defines a large aircraft as any aircraft of more than 12,500 pounds maximum certificated takeoff weight, which can also be considered a large aircraft in the present context, but the focus of size is generally related to a length of the aircraft herein. One example of such an oversized payload capable of being transported using examples of this present disclosure are wind turbine blades, the largest of which can be over 100 meters in length. Examples of the present disclosure enable a payload of such an extreme length to be transported within the cargo bay of an aircraft having a fuselage length only slighter longer than the payload, while that aircraft can also take off and land at most existing commercial airports, as well as runways that are even smaller, for instance because they are built at a desired location for landing such cargo aircraft near a site where the cargo is to be used, such as a landing strip built near or as part of a wind farm.

Examples of the present disclosure include a structural arrangement for an upper-wing fuselage cutout for supporting a large upper-wing. Examples of the high wing aircraft for which this design is illustrated herein can have a significant cutout in the upper fuselage to allow the wing to partially nest into the upper portion of the fuselage to reduce its drag impact. With a large cutout at the top of the fuselage where the global fuselage bending moments are the largest, structural supports are needed to strengthen and stiffen the edges of that cutout. In some examples of the present disclosure, the cutout perimeter beams of the aircraft fuselage are closed box sections which increase their area moment of inertia and torsional stiffness providing for a dramatically increased stiffness to the edge of the cutout.

Examples of the present disclosure include a cargo aircraft having a fuselage defining a forward end, an aft end, and a continuous interior cargo bay that spans a majority of a length of the fuselage from the forward end to the aft end. The fuselage includes a fuselage wing cutout defined by a plurality of structural elements configured to transfer a wing load to the fuselage. The structural elements include opposite starboard and port longeron beams each spanning a longitudinal length of the cutout, the starboard and port longeron beams having an enclosed box beam construction.

The perimeter of structural elements can include forward and aft frame beams each spanning a lateral length of the cutout, at least one of the forward frame beams or the aft frame beams having an enclosed box beam construction. In some examples, both of the forward and aft frame beams have an enclosed box beam construction. In some examples, the fuselage includes: (i) a starboard structural interface between the one of the forward and aft frame beams having an enclosed box beam construction and the starboard longeron beam; and (ii) a port structural interface between the one of the forward and aft frame beams having an enclosed box beam construction and the port longeron beam. The starboard and port structural interfaces can also have an enclosed box construction. The starboard and port longeron beams and the forward and aft frame beams can define an approximately rectangular or trapezoidal opening into the fuselage. The fuselage wing cutout can define an opening into the continuous interior cargo bay such that a wing, when attached, encloses the contentions interior cargo bay.

In some examples, the continuous interior cargo bay extends along all of the longitudinal length of the fuselage wing cutout. The enclosed box beam construction can include a plurality of panel sections, at least one of the plurality of panel sections comprising a skin panel of the fuselage. The enclosed box beam construction can include a four panel construction including: (1) a skin panel of the fuselage; (2) an upper panel extending inward from the skin panel; (3) a lower panel extending inward from the skin panel; and (4) an inner panel extending from the upper panel to the lower panel. In some instances, the fuselage wing cutout includes an upper cutout formed as a cutout in a top region of the fuselage and the plurality of structural elements can be arranged around a perimeter of the upper cutout.

The fuselage can include a forward transverse frame section located forward of the fuselage wing cutout and an aft transverse frame section located aft of the fuselage wing cutout. The starboard and port longeron beams can each extend from the forward transverse frame section to the aft transverse frame section. In some examples, the perimeter of structural elements includes forward and aft frame beams each spanning a lateral length of the cutout. In at least some such embodiments, at least one of the forward and aft frame beams can have an enclosed box beam construction having a plurality of panel sections, and at least one of the plurality of panel sections can include a web panel of a respective forward or transverse frame section.

The fuselage of the cargo aircraft can include a forward portion, an aft portion, and a kinked portion. The forward portion can contain a forward region of the continuous interior cargo bay, with the forward portion defining a forward centerline along a longitudinal-lateral plane of the cargo aircraft. The aft portion can contain an aft region of the continuous interior cargo bay, with the aft portion defining an aft centerline extending above the longitudinal-lateral plane of the cargo aircraft. The kinked portion can form a junction in the fuselage between the forward portion and the aft portion of the fuselage and between the forward and aft regions of the continuous interior cargo bay. The kinked portion can contain a transition region of the continuous interior cargo bay and can define a bend angle between the forward centerline and the aft centerline. The forward transverse frame section can be located in the forward portion of the fuselage.

A forward end or an aft end of at least one of the starboard or port longeron beams can terminate with a tapered section that defines an enclosed box beam with a cross-section that tapers away from the cutout and along a skin panel of the fuselage.

In some examples, the cargo aircraft can include a first fixed wing extending from the fuselage in a first direction away from the fuselage, a second fixed wing extending from the fuselage in a second direction away from the fuselage, with the second direction approximately symmetric about a longitudinal-vertical center plane of the cargo aircraft. The aircraft can further include a wing box extending between the first fixed wing and the second fixed wing and along the fuselage wing cutout. The wing box can be secured to the plurality of structural elements of the fuselage wing cutout. The fuselage wing cutout can include an upper cutout formed as a cutout in a top region of the fuselage. Further, the cargo aircraft can have an upper (high) wing configuration with a wing structural torque box continuous from wing tip to wing tip through the fuselage cutout.

In some examples, the length of the fuselage is greater than about 84 meters, and the continuous interior cargo bay can define a maximum payload length of at least about 70 meters

Another example of the present disclosure is a cargo aircraft that includes a fuselage defining a forward end, an aft end, and a continuous interior cargo bay that spans a majority of a length of the fuselage from the forward end to the aft end. The fuselage includes a forward portion, an aft portion, a kinked portion, and a wing cutout. The forward portion contains a forward region of the continuous interior cargo bay and defines a forward centerline along a longitudinal-lateral plane of the cargo aircraft. The aft portion contains an aft region of the continuous interior cargo bay and defines an aft centerline extending above the longitudinal-lateral plane of the cargo aircraft. The kinked portion forms a junction in the fuselage between the forward portion and the aft portion of the fuselage and between the forward and aft regions of the continuous interior cargo bay. The kinked portion contains a transition region of the continuous interior cargo bay and defines a bend angle between the forward centerline and the aft centerline. The fuselage wing cutout is defined by a plurality of structural elements configured to transfer a wing load to the fuselage. The structural elements include opposite starboard and port longeron beams, each spanning a longitudinal length of the cutout. The starboard and port longeron beams have an enclosed box beam construction. The cargo aircraft also includes a first fixed wing extending from the fuselage in a first direction away from the fuselage, a second fixed wing extending from the fuselage in a second direction away from the fuselage, with the second direction approximately symmetric about a longitudinal-vertical center plane of the cargo aircraft. Still further, the cargo aircraft includes a wing box that connects the first fixed wing box to the second fixed wing box and extends along the fuselage wing cutout. The wing box is secured to the plurality of structural elements of the fuselage wing cutout.

In some embodiments, the wing cutout can include an upper cutout formed as a cutout in a top region of the fuselage. The cargo aircraft can have an upper wing configuration with an upper wing surface that extends across the top of the aircraft from the first fixed wing to the second fixed wing. In some such embodiments, the plurality of structural elements can be arrange around a perimeter of the upper cutout. The wing box can be located forward of the kinked portion.

The perimeter of structural elements can include forward and aft frame beans, each spanning a lateral length of the cutout. At least one of the forward and aft frame beams can have an enclosed box beam construction. In some embodiments, both the forward and aft frame beams can have an enclosed box beam construction. The aircraft can include a starboard structural interface between the one of the forward and aft frame beams having an enclosed box beam construction and the starboard longeron beam. It can also include a port structural interface between the one of the forward and aft frame beams having an enclosed box beam construction and the port longeron beam. In some such embodiments, the starboard and port structural interfaces can have an enclosed box construction. In some embodiments, the starboard and port longeron beams and the forward and aft frame beams can define an approximately rectangular or trapezoidal opening into the fuselage.

The continuous interior cargo bay can extend along all, or substantially all, of the longitudinal length of the cutout. The enclosed box beam construction can include a plurality of panel sections. In at least some such embodiments, at least one of the plurality of panel sections can include a skin panel of the fuselage. The enclosed box beam construction can include a four panel construction. Such construction can include, for example: (1) a skin panel of the fuselage; (2) an upper panel extending inward from the skin panel; (3) a lower panel extending inward from the skin panel; and (4) an inner panel extending from the upper panel to the lower panel.

### BRIEF DESCRIPTION OF DRAWINGS

This disclosure will be more fully understood from the following detailed description taken in conjunction with the accompanying drawings, in which:

FIG. 1A is an isometric view of one exemplary embodiment of an aircraft;

FIG. 1B is a side view of the aircraft of FIG. 1A;

FIG. 2A is an isometric view of the aircraft of FIG. 1A with a nose cone door in an open position to provide access to an interior cargo bay of the aircraft;

FIG. 2B is an isometric view of the aircraft of FIG. 2A with a payload being disposed proximate to the aircraft for loading into the interior cargo bay;

FIG. 2C is an isometric, partial cross-sectional view of the aircraft of FIG. 2B with the payload being partially loaded into the interior cargo bay;

FIG. 2D is an isometric, partial cross-sectional view of the aircraft of FIG. 2C with the payload being fully loaded into the interior cargo bay;

FIG. 3 is a schematic side view of an aircraft in the prior art, illustrating a lateral axis of rotation with respect to tail strike;

FIG. 4A is a side view of an alternative exemplary embodiment of an aircraft;

FIG. 4B is a side transparent view of the aircraft of FIG. 4A;

FIG. 4C is a side view of the aircraft of FIG. 4B in a take-off position;

FIG. 5A is the side view of the aircraft of FIG. 1A with some additional details removed for clarity;

FIG. 5B is the side view of the aircraft of FIG. 1A showing the vertical extension of the aft fuselage above the forward portion of the fuselage;

FIG. 6A is a side cross-sectional view of the aircraft of FIG. 5A, including an interior cargo bay of the aircraft;

FIG. 6B is the side cross-sectional view of the aircraft of FIG. 6A with an exemplary payload disposed in the interior cargo bay;

FIG. 6C is the side cross-sectional view of the aircraft of FIG. 6A with a schematic of an exemplary maximum-length payload disposed in the interior cargo bay;

FIG. 6D is the side cross-sectional view of the aircraft of FIG. 6A with a schematic of an exemplary maximum-weight payload disposed in the interior cargo bay of the aircraft;

FIG. 7 is an isometric view of the aircraft of FIG. 6A illustrating a lower support system that extends along the interior cargo bay from a forward entrance to an aft section of the interior cargo bay in an aft portion of a fuselage of the aircraft;

FIG. 8A is a side view of one exemplary embodiment of structural elements of a cargo aircraft fuselage;

FIG. 8B is an isometric view of the fuselage of FIG. 8A;

FIG. 8C is a close-up isometric view of a central portion of the fuselage of FIG. 8B

having an upper cutout;

FIG. 8D is a side view of the central portion of the fuselage of FIG. 8C showing a fuselage skin and a wing box passes across the upper cutout;

FIG. 8E is an isometric view of the central portion of the fuselage of FIG. 8A showing the transverse frame elements;

FIG. 9A is an isometric view of a center fuselage section showing an upper-wing cutout incorporating perimeter box beams;

FIG. 9B is an isometric view of the center fuselage section of FIG. 9A showing the perimeter box beams in solid presentation with the rest of the fuselage in wireframe;

FIG. 9C is a cross-section side view of the inner surface of the center fuselage section of FIG. 9A showing the individual panels of the perimeter box beams;

FIG. 10A is a cross section schematic of an example of port and starboard box beam longerons forming an upper cutout;

FIG. 10B is a cross section schematic of an alternate example of port and starboard box beam longerons forming an upper cutout;

FIG. 10C is a cross section schematic of an example of forward and aft box beam frames forming an upper cutout;

FIG. 11A is an isometric view of a center fuselage section showing an upper-wing cutout incorporating perimeter box beams;

FIG. 11B is a lower isometric view of the center fuselage section of FIG. 11A; and

FIG. 11C is a cross-section side view of the inner surface of the center fuselage section of FIG. 11A showing the individual panels of the perimeter box beams.

### DETAILED DESCRIPTION

Certain exemplary embodiments will now be described to provide an overall understanding of the principles of the structure, function, manufacture, and use of the devices, systems, aircraft, and methods disclosed herein. One or more examples of these embodiments are illustrated in the accompanying drawings. Those skilled in the art will understand that the devices, systems, aircraft, components related to or otherwise part of such devices, systems, and aircraft, and methods specifically described herein and illustrated in the accompanying drawings are non-limiting embodiments and that the scope of the present disclosure is defined solely by the claims. The features illustrated or described in connection with one embodiment may be combined with the features of other embodiments. Such modifications and variations are intended to be included within the scope of the present disclosure. Some of the embodiments provided for herein may be schematic drawings, including possibly some that are not labeled as such but will be understood by a person skilled in the art to be schematic in nature. They may not be to scale or may be somewhat crude renderings of the disclosed components. A person skilled in the art will understand how to implement these teachings and incorporate them into work systems, methods, aircraft, and components related to each of the same, provided for herein.

To the extent the present disclosure includes various terms for components and/or processes of the disclosed devices, systems, aircraft, methods, and the like, one skilled in the art, in view of the claims, present disclosure, and knowledge of the skilled person, will understand such terms are merely examples of such components and/or processes, and other components, designs, processes, and/or actions are possible. By way of non-limiting example, while the present application describes loading an airplane through a front end of the aircraft, alternatively, or additionally, loading can occur through an aft end of the aircraft and/or from above and/or below the aircraft. In the present disclosure, like-numbered and like-lettered components of various embodiments generally have similar features when those components are of a similar nature and/or serve a similar purpose. To the extent terms such as front, back, top, bottom, forward, aft, proximal, distal, etc. are used to describe a location of various components of the various disclosures, such usage is by no means limiting, and is often used for convenience when describing various possible configurations. The foregoing notwithstanding, a person skilled in the art will recognize the common vernacular used with respect to aircraft, such as the terms “forward” and “aft,” and will give terms of those nature their commonly understood meaning. Further in some instances, terms like forward and proximal or aft and distal may be used in a similar fashion.

The present disclosure is related to large, transport-category aircraft (e.g., fixed-wing, non-buoyant, and multi-engine jet aircraft), capable of moving oversized cargo not traditionally shippable by air. For example, wind turbine blades, which are typically highly elongated and irregular in shape in order to provide greater electrical power generating efficiency, or similarly long industrial equipment, shipping containers, or military equipment. The present disclosure is not limited to these specific cargos or payloads, but rather, these are examples. Example of the present disclosure include extremely long cargo aircraft (e.g., longer than 60 meters, or even longer than 84 meters) with a kink in their fuselage about the lateral pitch axis, which allows the transportation of very long payloads or cargos while also meeting the tail strike requirement by allowing the cargo to extend longitudinally aft and upwards to locations which are vertically above the upper surface of the forwards fuselage.

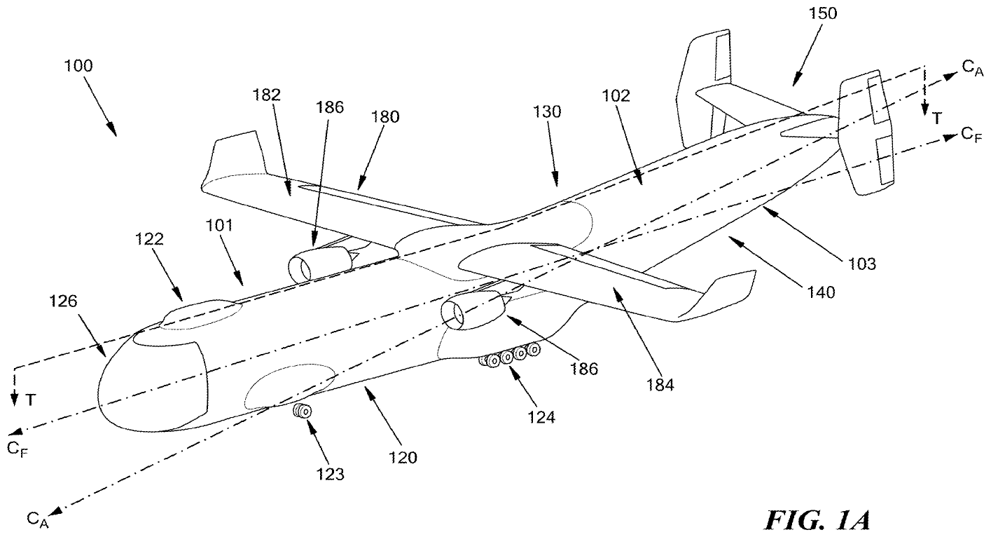

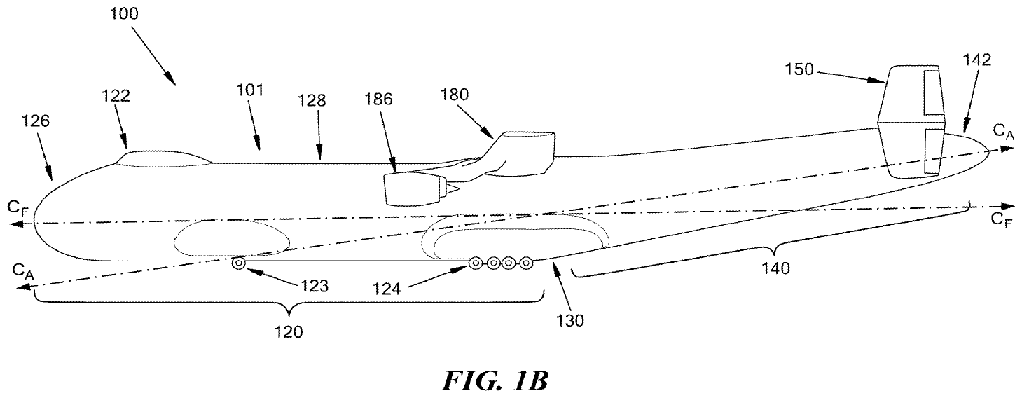

Fixed-wing aircraft traditionally receive the vast majority of their lifting force from a primary wing that passes through the body of the fuselage in order to deliver the lifting force to the rest of the aircraft. As the size and weight-carrying capabilities of an aircraft increase, so too must the lifting force, and thus the size of the wing increase. Additionally, aircraft, especially large aircraft, designed to have short takeoff and landing requirements also need more lift at lower speed than aircraft able to utilize a longer runway, and thus takeoff and land at a higher speed. Accordingly, very large cargo aircraft with very short runway requirements best meet these requirements by having very large fixed wings, which increases the size of the interface between the wing and the fuselage, and as the size of this interface increases, so too does the stress put on the structural members that must span the cutout for the wing and both brace the forward and aft fuselage sections together and robustly transfer the primary lifting forces between the wings and the fuselage. Aspects of the present disclosure include structural configurations for large wing cutouts in fuselages, especially upper-wing configurations, which include the use of box beam longerons to span the fuselage wing cutout and strengthen the interface between the wing and the fuselage. One such large cargo aircraft with short takeoff and landing requirements is illustrated in FIGS. 1A and 1B.

### Aircraft

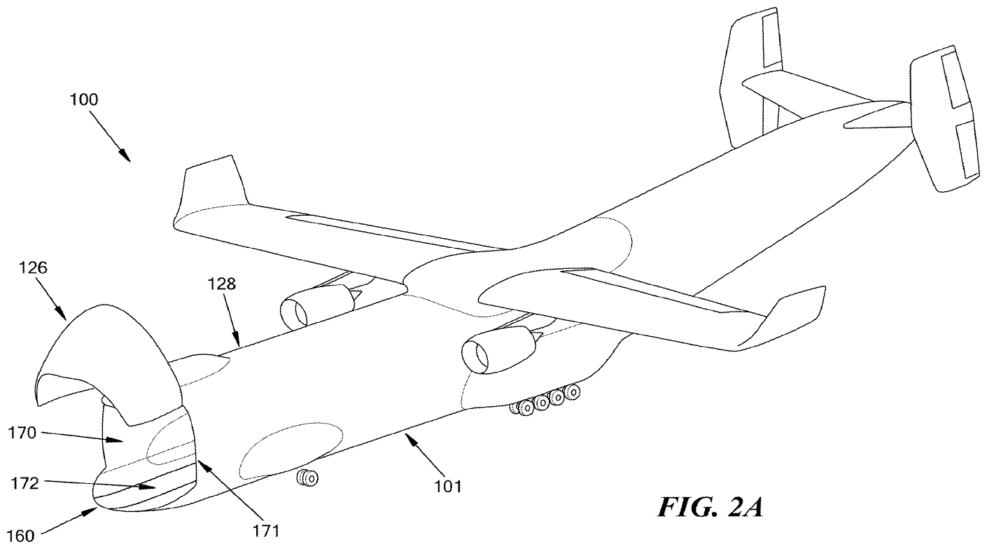

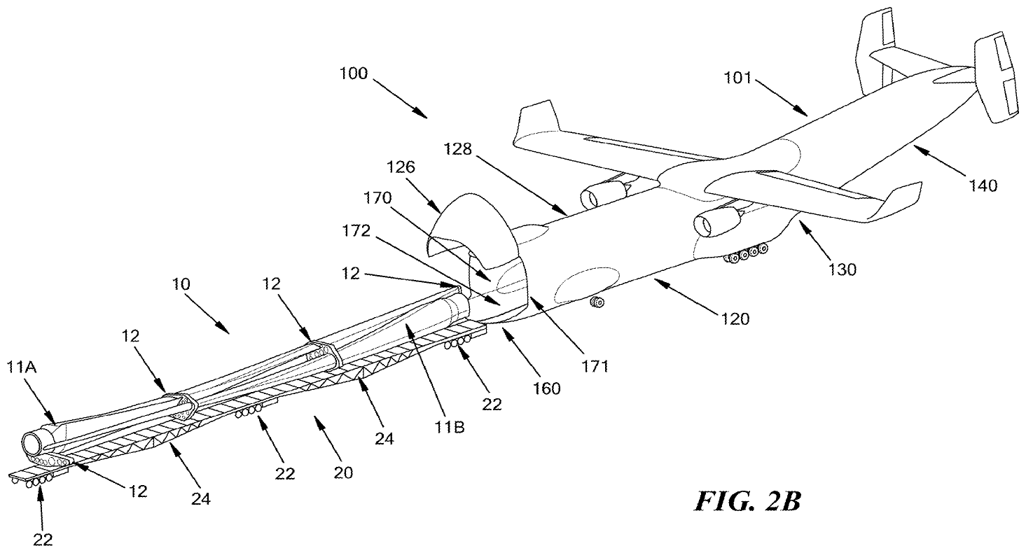

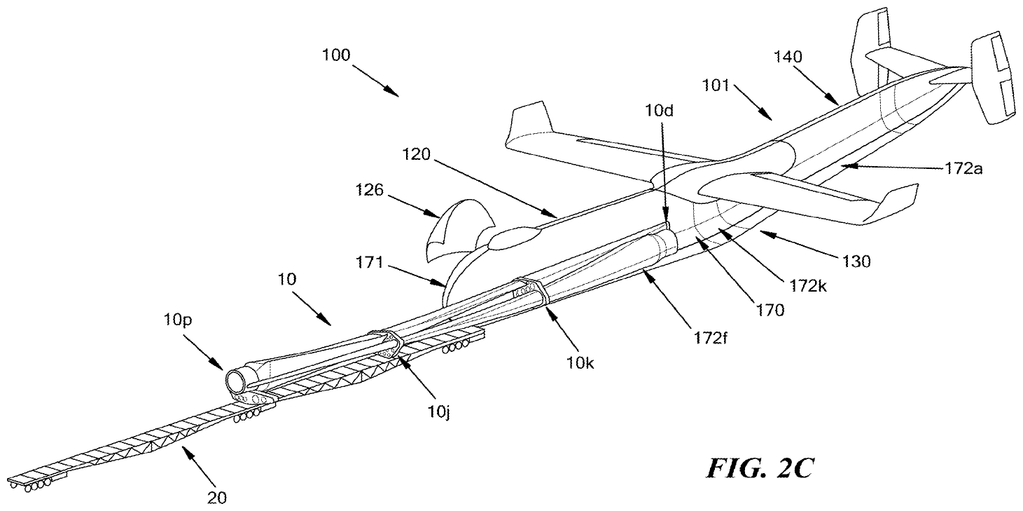

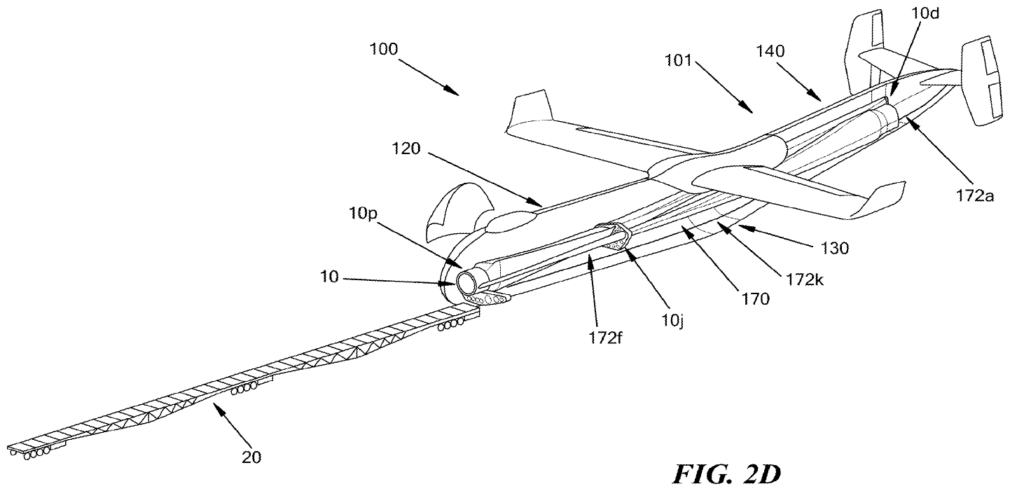

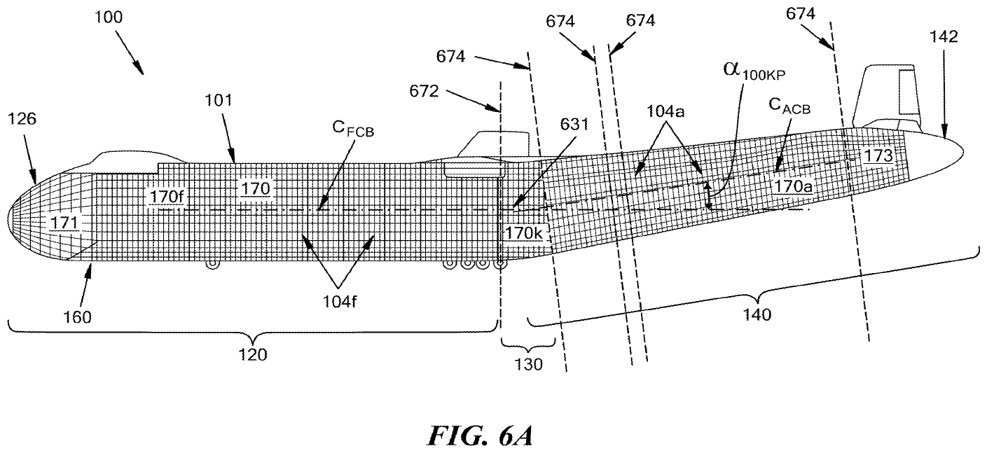

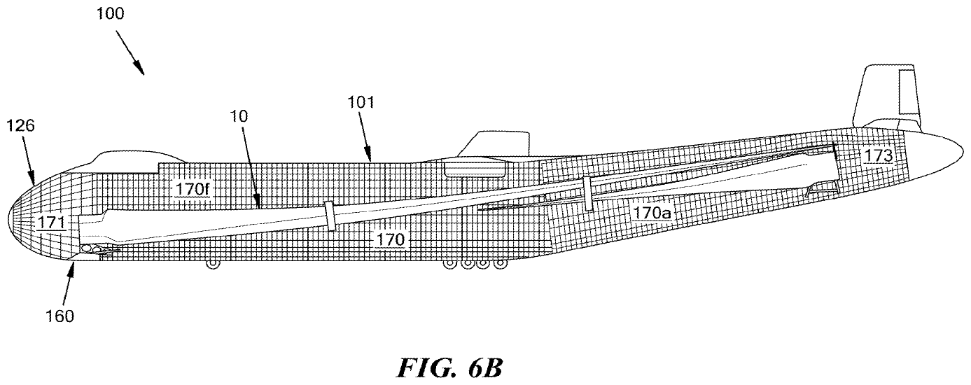

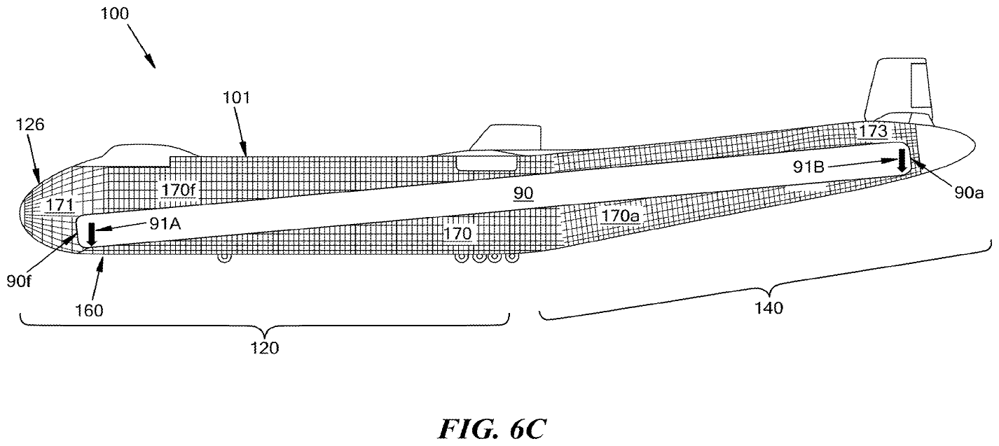

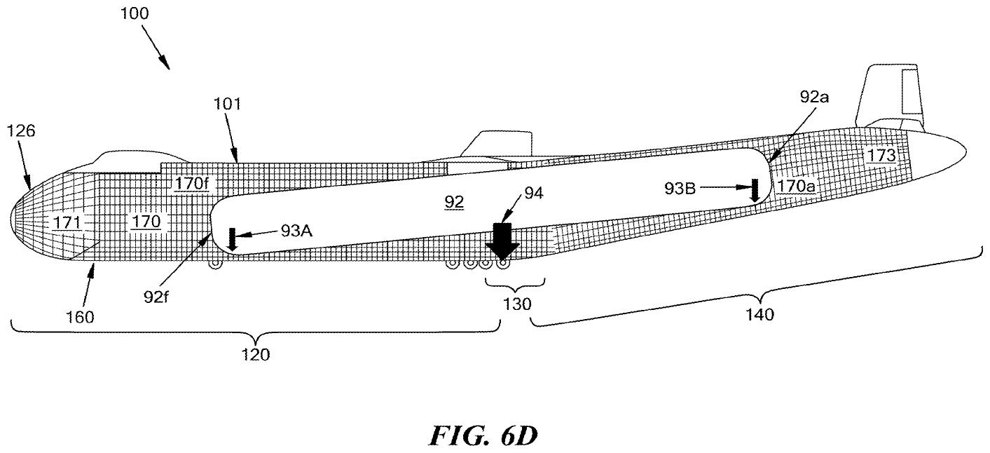

The focus of the present disclosures is described with respect to a large aircraft 100, such as an airplane, illustrated in FIGS. 1A and 1B, along with the loading of a large payload into the aircraft, illustrated at least in FIGS. 2A-2D, and 6B-6D. Additional details about the aircraft and payload may be described with respect to the other figures of the present disclosure as well. In the illustrated embodiment, a payload 10 is a combination of two wind turbine blades 11A and 11B (FIGS. 2B-2D), although a person skilled in the art will appreciate that other payloads are possible. Such payloads can include other numbers of wind turbine blades (e.g., one, three, four, five, etc., or segments of a single even larger blade), other components of wind turbines (e.g., tower segments, generator, nacelle, gear box, hub, power cables, etc.), or many other large structures and objects whether related to wind turbines or not. The present application can be used in conjunction with most any large payload—large for the present purposes being at least about 57 meters long, or at least about 60 meters long, or at least about 65 meters long, or at least about 75 meters long, or at least about 85 meters long, or at least about 90 meters long, or at least about 100 meters long, or at least about 110 meters long, or at least about 120 meters long—or for smaller payloads if desired. Some non-limiting examples of large payloads that can be used in conjunction with the present disclosures beyond wind turbines include but are not limited to industrial oil equipment, mining equipment, rockets, military equipment and vehicles, commercial aerospace vehicles, crane segments, aircraft components, space launch rocket boosters, helicopters, generators, or hyperloop tubes. In other words, the aircraft 100 can be used with most any size and shape payload, but has particular utility when it comes to large, often heavy, payloads.

As shown, for example in FIGS. 1A-1B and 2A-2D, the aircraft 100, and thus its fuselage 101, includes a forward end 120 and an aft end 140, with a kinked portion 130 connecting the forward end 120 to the aft end 140. The forward end 120 is generally considered any portion of the aircraft 100, and related components, that are forward of the kinked portion 130 and the aft end 140 is considered any portion of the aircraft 100, and related components, that are aft of the kinked portion 130. The kinked portion 130, as described in greater detail below, is a section of the aircraft 130 in which both a top-most outer surface 102 and a bottom-most outer surface 103 of the fuselage 101 become angled (notably, the placement of reference numerals 102 and 103 in the figures do not illustrate location of the “kink” since they more generally refer to the top-most and bottom-most surfaces of the fuselage 101), as illustrated by an aft centerline C_{A} of the aft end 140 of the fuselage 101 with respect to a forward centerline C_{F} of the forward end 120 of the fuselage 101.

The forward end 120 can include a cockpit or flight deck 122, and landing gears, as shown a forward or nose landing gear 123 and a rear or main landing gear 124. The illustrated embodiment does not show various components used to couple the landing gears 123, 124 to the fuselage 101, or operate the landing gears (e.g., actuators, braces, shafts, pins, trunnions, pistons, cylinders, braking assemblies, etc.), but a person skilled in the art will appreciate how the landing gears 123, 124 are so connected and operable in conjunction with the aircraft 100. The forward-most end of the forward end 120 includes a nose cone 126. As illustrated more clearly in FIG. 2A, the nose cone 126 is functional as a door, optionally being referred to the nose cone door, thus allowing access to an interior cargo bay 170 defined by the fuselage 101 via a cargo opening 171 exposed by moving the nose cone door 126 into an open or loading position (the position illustrated in FIG. 2A; FIGS. 1A and 1B illustrate the nose cone door 126 in a closed or transport position). The door may operate by rotating vertically tip-upwards about a lateral axis, or by rotating horizontally tip-outboards about a vertical axis, or by other means as well such as translation forwards then in other directions, or by paired rotation and translation, or other means.

As described in greater detail below, the interior cargo bay 170 is continuous throughout the length of the aircraft 101, i.e., it spans a majority of the length of the fuselage. The continuous length of the interior cargo bay 170 includes the space defined by the fuselage 101 in the forward end 120, the aft end 140, and the kinked portion 130 disposed therebetween, such spaces being considered corresponding to the forward bay, aft bay, and kinked bay portions of the interior cargo bay 170. The interior cargo bay 170 can thus include the volume defined by nose cone 126 when it is closed, as well as the volume defined proximate to a fuselage tail cone 142 located at the aft end 140. In the illustrated embodiment of FIG. 2A, the nose cone door 126 is hinged at a top such that it swings clockwise towards the fuselage cockpit 122 and a fixed portion or main section 128 of the fuselage 101. In other embodiments, a nose cone door can swing in other manners, such as being hinged on a left or right side to swing clockwise or counter-clockwise towards the fixed portion 128 of the fuselage. The fixed portion 128 of the forwards fuselage 101 is the portion that is not the nose cone 126, and thus the forwards fuselage 101 is a combination of the fixed portion 128 and the nose cone 126. Alternatively, or additionally, the interior cargo bay 170 can be accessed through other means of access known to those skilled in the art, including but not limited to a hatch, door, and/or ramp located in the aft end 140 of the fuselage 101, hoisting cargo into the interior cargo bay 170 from below, and/or lowering cargo into the interior cargo bay 170 from above. One advantage provided by the illustrated configuration, at least as it relates to some aspects of loading large payloads, is that by not including an aft door, the interior cargo bay 170 can be continuous, making it significantly easier to stow cargo in the aft end 140 all the way into the fuselage tail cone 142. While loading through an aft door is possible with the present disclosures, doing so would make loading into and use of the interior cargo bay 170 space in the aft end 140 all the way into the fuselage tail cone 142 much more challenging and difficult to accomplish—a limitation faced in existing cargo aircraft configurations. Existing large cargo aircraft are typically unable to add cargo in this way (e.g., upwards and aftwards) because any kink present in their aft fuselage is specifically to create more vertical space for an aft door to allow large cargo into the forwards portion of the aircraft.

A floor 172 can be located in the interior cargo bay 170, and can also extend in a continuous manner, much like the bay 170 itself, from the forward end 120, through the kinked portion 130, and into the aft end 140. The floor 172 can thus be configured to have a forward end 172f, a kinked portion 172k, and an aft end 172a. In some embodiments, the floor 172 can be configured in a manner akin to most floors of cargo bays known in the art. In some other embodiments, discussed in greater detail below, one or more rails can be disposed in the interior cargo bay 170 and can be used to assist in loading a payload, such as the payload 10, into the interior cargo bay 170 and/or used to help secure the location of a payload once it is desirably positioned within the interior cargo bay 170.

Opening the nose cone 126 not only exposes the cargo opening 171 and the floor 172, but it also provides access from an outside environment to a cantilevered tongue 160 that extends from or otherwise defines a forward-most portion of the fixed portion 128 of the fuselage 101. The cantilevered tongue can be an extension of the floor 172, or it can be its own feature that extends from below or above the floor 172 and associated bottom portion of the fuselage 101. The cantilevered tongue 160 can be used to support a payload, thus allowing the payload to extend into the volume of the interior cargo bay 170 defined by the nose cone 126.

A wingspan 180 can extend substantially laterally in both directions from the fuselage. The wingspan 180 includes both a first fixed wing 182 and a second fixed wing 184, the wings 182, 184 extending substantially perpendicular to the fuselage 101 in respective first and second directions which are approximately symmetric about a longitudinal-vertical plane away from the fuselage 101, and more particularly extending substantially perpendicular to the centerline C_{F}. Wings 182, 184 being indicated as extending from the fuselage 101 do not necessarily extend directly away from the fuselage 101, i.e., they do not have to be in direct contact with the fuselage 101. Further, the opposite directions the wings 182, 184 extend from each other can alternatively be described as the second wing 184 extending approximately symmetrically away from the first wing 182. As shown, the wings 182, 184 define approximately no sweep angle and no dihedral angle. In alternative embodiments, a sweep angle can be included in the tip-forwards (−) or tip-aftwards (+) direction, the angle being approximately in the range of about −40 degrees to about +60 degrees. In other alternative embodiments, a dihedral angle can be included in the tip-downwards (negative, or “anhedral”) or tip-upwards (positive, or “dihedral”) direction, the angle being approximately in the range of about −5 degrees to about +5 degrees. Other typical components of wings, including but not limited to slats for increasing lift, flaps for increasing lift and drag, ailerons for changing roll, spoilers for changing lift, drag, and roll, and winglets for decreasing drag can be provided, some of which a person skilled in the art will recognize are illustrated in the illustrations of the aircraft 100 (other parts of wings, or the aircraft 100 more generally, not specifically mentioned in this detailed description are also illustrated and recognizable by those skilled in the art). Engines, engine nacelles, and engine pylons 186 can also be provided. In the illustrated embodiment, two engines 186, one mounted to each wing 182, 184 are provided. Additional engines can be provided, such as four or six, and other locations for engines are possible, such as being mounted to the fuselage 101 rather than the wings 182, 184.

The kinked portion 130 provides for an upward transition between the forward end 120 and the aft end 140. The kinked portion 130 includes a kink, i.e., a bend, in the fixed portion 128 of the fuselage 101 such that both the top-most outer surface 102 and the bottom-most outer surface 103 of the fuselage 101 become angled with respect to the centerline C_{F} of the forward end 120 of the aircraft 100, i.e., both surfaces 102, 103 include the upward transition provided for by the kinked portion 130. As shown at least in FIG. 1B, the aft-most end of the aft end 140 can raise entirely above the centerline C_{F}. In the illustrated embodiment, the angle defined by the bottom-most outer surface 103 and the centerline C_{F} is larger than an angle defined by the top-most outer surface 102 and the centerline C_{F}, although other configurations may be possible. Notably, although the present disclosure generally describes the portions associated with the aft end 140 as being “aft,” in some instances they may be referred to as part of a “kinked portion” or the like because the entirety of the aft end 140 is angled as a result of the kinked portion 130. Thus, references herein, including in the claims, to a kinked portion, a kinked cargo bay or cargo bay portion, a kinked cargo centerline, etc. will be understood by a person skilled in the art, in view of the present disclosures, to be referring to the aft end 140 of the aircraft 100 (or the aft end in other aircraft embodiments) in some instances.

Despite the angled nature of the aft end 140, the aft end 140 is well-suited to receive cargo therein. In fact, the aircraft 100 is specifically designed in a manner that allows for the volume defined by the aft end 140, up to almost the very aft-most tip of the aft end 140, i.e., the fuselage tail cone 142, can be used to receive cargo as part of the continuous interior cargo bay 170. Proximate to the fuselage tail cone 142 can be an empennage 150, which can include horizontal stabilizers for providing longitudinal stability, elevators for controlling pitch, vertical stabilizers for providing lateral-directional stability, and rudders for controlling yaw, among other typical empennage components that may or may not be illustrated but would be recognized by a person skilled in the art.

The aircraft 100 is particularly well-suited for large payloads because of a variety of features, including its size. A length from the forward-most tip of the nose cone 126 to the aft-most tip of the fuselage tail cone 142 can be approximately in the range of about 60 meters to about 150 meters. Some non-limiting lengths of the aircraft 100 can include about 80 meters, about 84 meters, about 90 meters, about 95 meters, about 100 meters, about 105 meters, about 107 meters, about 110 meters, about 115 meters, or about 120 meters. Shorter and longer lengths are possible. A volume of the interior cargo bay 170, inclusive of the volume defined by the nose cone 126 and the volume defined in the fuselage tail cone 142, both of which can be used to stow cargo, can be approximately in the range of about 1200 cubic meters to about 12,000 cubic meters, the volume being dependent at least on the length of the aircraft 100 and an approximate diameter of the fuselage (which can change across the length). One non-limiting volume of the interior cargo bay 170 can be about 6850 cubic meters. Not accounting for the very terminal ends of the interior cargo bay 170 where diameters get smaller at the terminal ends of the fuselage 101, diameters across the length of the fuselage, as measured from an interior thereof (thus defining the volume of the cargo bay) can be approximately in the range of about 4.3 meters to about 13 meters, or about 8 meters to 11 meters. One non-limiting diameter of the fuselage 101 proximate to its midpoint can be about 9 meters. The wingspan, from tip of the wing 132 to the tip of the wing 134, can be approximately in the range of about 60 meters to 110 meters, or about 70 meters to about 100 meters. One non-limiting length of the wingspan 180 can be about 80 meters. A person skilled in the art will recognize these sizes and dimensions are based on a variety of factors, including but not limited to the size and mass of the cargo to be transported, the various sizes and shapes of the components of the aircraft 100, and the intended use of the aircraft, and thus they are by no means limiting. Nevertheless, the large sizes that the present disclosure both provides the benefit of being able to transport large payloads, but faces challenges due, at least in part, to its size that make creating such a large aircraft challenging. The engineering involved is not merely making a plane larger. As a result, many innovations tied to the aircraft 100 provided for herein, and in other commonly-owned patent applications, are the result of very specific design solutions arrived at by way of engineering.

Materials typically used for making fuselages can be suitable for use in the present aircraft 100. These materials include, but are not limited to, metals and metal alloys (e.g., aluminum alloys), composites (e.g., carbon fiber-epoxy composites), and laminates (e.g., fiber-metallic laminates), among other materials, including combinations thereof.

FIGS. 2B-2D provide for a general, simplified illustration of one exemplary embodiment of loading a large payload 10 into the aircraft 100. As shown, the cargo nose door 126 is swung upwards into its open position, exposing the portion of the interior cargo bay 170 associated with the fixed portion 128 of the fuselage 101, which can extend through the kinked portion 130 and through essentially the entirety of the aft end 140. The cargo opening 171 provides access to the interior cargo bay 170, and the cantilevered tongue 160 can be used to help initially receive the payload. As shown, the payload 10 includes two wind turbine blades 11A, 11B, held with respect to each other by payload-receiving fixtures 12. The payload-receiving fixtures 12 are generally considered part of the payload, although in an alternative interpretation, the payload 10 can just be configured to be the blades 11A, 11B. This payload 10 can be considered irregular in that the shape, size, and weight distribution across the length of the payload is complex, causing a center of gravity of the payload to be at a separate location than a geometric centroid of the payload. One dimension (length) greatly exceeds the others (width and height), the shape varies with complex curvature nearly everywhere, and the relative fragility of the payload requires a minimum clearance be maintained at all times as well as fixturing support the length of the cargo at several locations even under the payload's own weight under gravity. Additional irregular payload criteria can include objects with profiles normal to a lengthwise axis rotate at different stations along that axis, resulting in a lengthwise twist (e.g., wind turbine blade spanwise twist) or profiles are located along a curved (rather than linear) path (e.g., wind turbine blade in-plane sweep). Additionally, irregular payloads include objects where a width, depth, or height vary non-monotonically along the length of the payload (e.g., wind turbine blade thickness can be maximal at the max chord station, potentially tapering to a smaller cylinder at the hub and to a thin tip). The term irregular package will be similarly understood.

The payload 10, which can also be referred to as a package, particularly when multiple objects (e.g., more than one blade, a blade(s) and ballast(s)) are involved, possibly secured together and manipulated as a single unit, can be delivered to the aircraft 100 using most any suitable devices, systems, vehicles, or methods for transporting a large payload on the ground. A package can involve a single object though. In the illustrated embodiment, a transport vehicle 20 includes a plurality of wheeled mobile transporters 22 linked together by a plurality of spans, as shown trusses 24. In some instances, one or more of the wheeled mobile transporters 22 can be self-propelled, or the transport vehicle 20 more generally can be powered by itself in some fashion. Alternatively, or additionally, an outside mechanism can be used to move the vehicle 20, such as a large vehicle to push or pull the vehicle 20, or various mechanical systems that can be used to move large payloads, such as various combinations of winches, pulleys, cables, cranes, and/or power drive units.

As shown in FIG. 2B, the transport vehicle 20 can be driven or otherwise moved to the forward end 120 of the aircraft 100, proximate to the cargo opening 171. Subsequently, the payload 10 can begin to be moved from the transport vehicle 20 and into the interior cargo bay 170. This can likewise be done using various combinations of one or more winches, pulleys, cables, cranes, and/or power drive units, such set-ups and configurations being known to those skilled in the art. FIG. 2C illustrates a snapshot of the loading process with half of the fuselage removed for illustrative purposes (as currently shown, the half of the nose cone 126 illustrated is in both an open and closed position, but during loading through the cargo opening 171, it is in an open position). As shown, the payload 10 is partially disposed in the interior cargo bay 170 and is partially still supported by the transport vehicle 20. A distal end 10d of the payload 10 is still disposed in the forward end 120, as it has not yet reached the kinked portion 130.

The system and/or methods used to move the payload 10 into the partially loaded position illustrated in FIG. 2C can continue to be employed to move the payload 10 into the fully loaded position illustrated in FIG. 2D. As shown, the distal end 10d of the payload 10d is disposed in the interior cargo bay 170 at the aft end 140, a proximal end 10p of the payload 10 is disposed in the interior cargo bay 170 at the forward end 120 (for example, on the cantilevered tongue 160, although the tongue is not easily visible in FIG. 2D), and the intermediate portion of the payload 10 disposed between the proximal and distal ends 10p, 10d extends from the forward end 120, through the kinked portion 130, and into the aft end 140. As shown, the only contact points with a floor of the interior cargo bay 170 (which for these purposes includes the tongue 160) are at the proximal and distal ends 10p, 10d of the payload 10 and at two intermediate points 10j, 10k between the proximal and distal ends 10p, 10d, each of which is supported by a corresponding fixture 12. In other embodiments, there may be fewer or more contact points, depending, at least in part, on the size and shape of each of the payload and related packaging, the size and shape of the cargo bay, the number of payload-receiving fixture used, and other factors. This illustrated configuration of the payload disposed in the interior cargo bay 170 is more clearly understood by discussing the configuration of the kinked fuselage (i.e., the fuselage 101 including the kinked portion 130) in greater detail. Once the payload 10 is fully disposed in the interior cargo bay 170, it can be secured within the cargo bay 170 using techniques provided for herein, in commonly-owned applications, or otherwise known to those skilled in the art.

### Kinked Fuselage

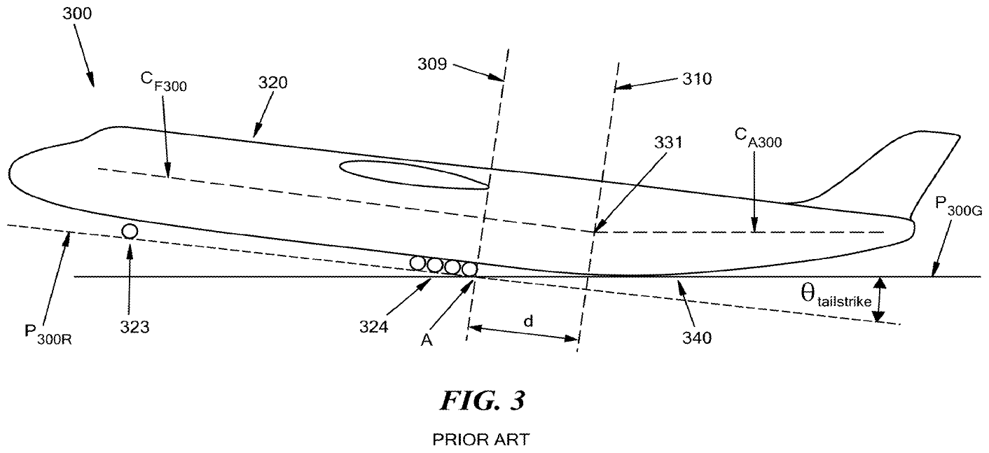

FIG. 3 is an illustration of a prior art aircraft 300 during a takeoff pitch-up maneuver showing the calculating of a tailstrike angle (θₜₐᵢₗₛₜᵣᵢₖₑ), which is determined when a forward end 320 of the aircraft 300 is lifted away from the ground P_{300G} (e.g., a runway of an airport) and an aft end 340 and tail of the aircraft 300 is pushed towards the ground 50 until contact. This change occurs during a takeoff pitch-up maneuver when the aircraft 300 pitches (e.g., rotates) about a lateral axis of rotation, indicated as “A” in FIG. 3. This lateral axis of rotation, A, is typically defined by the main landing gear 324, which acts as a pivot point to allow a downwards force generated by the tail to lift the forward end 320 of the aircraft 300. In FIG. 3, the nose landing gear 323 and main landing gear 324 of the aircraft 300 define a resting plane P_{300R} (e.g., plane horizontal with the ground plane P_{300G} when the aircraft is resting), such that the tailstrike angle θₜₐᵢₗₛₜᵣᵢₖₑcan be defined by the change in the angle of the ground plane P_{300G} with respect to the resting plane P_{300R} when the aircraft 300 has achieved a maximal pitch angle or takeoff angle, which occurs just before any part of the aft end 340 of the aircraft 300 strikes the ground. In FIG. 3, a forward center line C_{F300} of the aircraft 300 is shown, along with an aft centerline C_{A300}, which extends to the aft end 340 of the aircraft 300. In order to increase θₜₐᵢₗₛₜᵣᵢₖₑ, larger aircraft 300 usually have an upsweep to the lower surface of an aft region of the aft fuselage. This upsweep deflects the centerline C_{A300} with respect to the forward center line C_{F300} at the initiation of the upsweep, which is shown in FIG. 3 as a bend 331 in the centerlines C_{F300}, C_{A300}. In prior art aircraft 300, this bend 331 occurs a certain distance, shown in FIG. 3 as distance “d” aft of the lateral axis of rotation A. Longer values of distance “d” increase the constant cross-section length of the aircraft 300, which can, depending on the type of aircraft, extend the length of a passenger cabin and/or increase the length of the cargo bay, and thus the ability to carry cargo of an increased maximum length. Aspects of the present disclosure eschew this prior art incentive for increasing distance “d” and instead significantly reconfigure the relationship between the aft fuselage and forward fuselage such that decreasing distance “d” can result in increasing the maximum usable cargo bay length, as explained in more detail below.

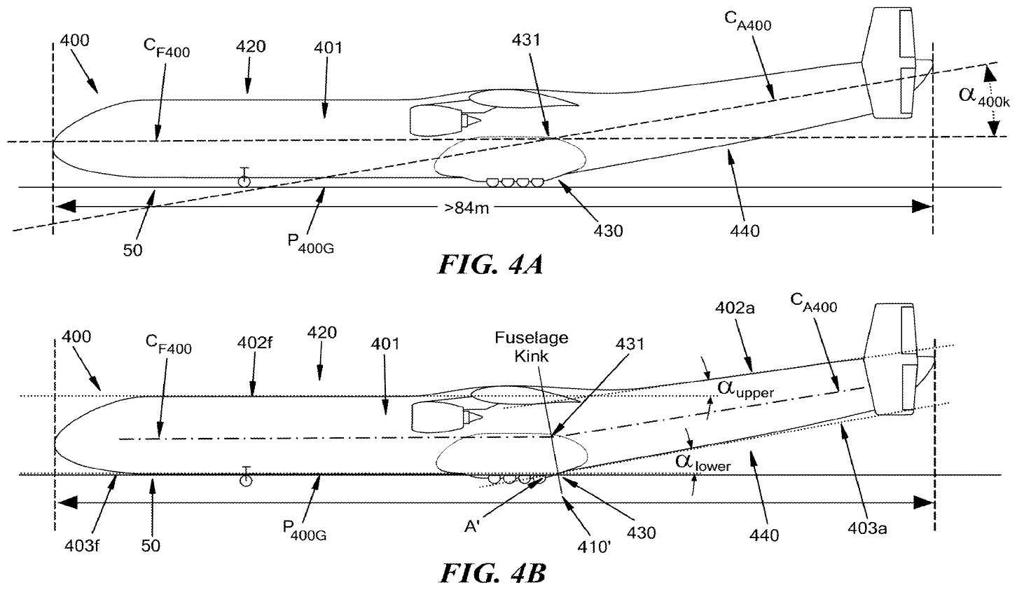

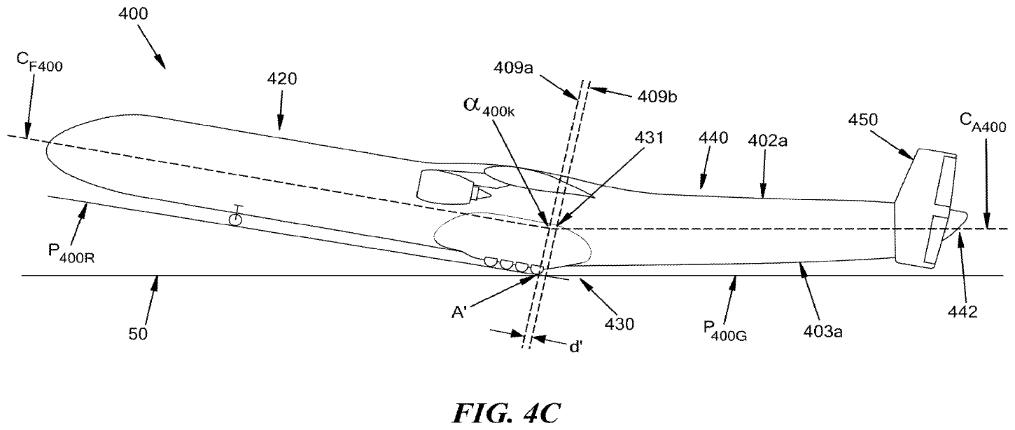

FIG. 4A is a side view illustration of an exemplary cargo aircraft 400 of the present disclosure. The aircraft 400, which is shown to be over 84 meters long, includes a fuselage 401 having a forward end 420 defining a forward centerline C_{F400} and an aft end 440 defining an aft centerline C_{A400}, with the aft centerline C_{A400} being angled up with respect to the forward centerline C_{F400}. The forward and aft centerlines C_{F400}, C_{A400} define a junction or kink 431 therebetween, where the forward centerline C_{F400} angles upward as the overall aft fuselage, which is in the aft end 440, changes in direction to be angled with respect to the forward fuselage, which is in the forward end 420. This defines a kink angle α₄₀₀ₖ of the aft fuselage 440. The kink location 431 is contained in the kinked portion 430 disposed between and connecting the forward and aft ends 420, 440. FIG. 4B shows the forward centerline C_{F400} as being an approximate midpoint between a top-most outer or upper surface 402f and a bottom-most outer or lower surface 403f of the fuselage 401 forward of a lateral axis of rotation A′, with the aft centerline C_{A400} being an approximate midpoint between an upper surface 402a and a lower surface 403a of the fuselage 401 aft of the lateral axis of rotation. FIG. 4B shows the kink 431 between the forward centerline C_{F400} and the aft centerline C_{A400} as being an approximate change in the angle of a plane 410′ substantially perpendicular to the centerline C_{F400} and most of the upper and lower surfaces 402a, 403a extending aft from the kink 431, such that the fuselage 401 aft of the kink 431 has a substantial portion of an approximately constant height or cross-sectional area. This represents only one example, and in other instances the upper surface 402a does not necessarily extend approximately parallel to the lower surface 402b at all even if the aft fuselage still defines a kink 431 in the centerline.

In FIG. 4B, the angle of the aft centerline C_{A400} with respect to the forward centerline C_{F400} defines a kink or bend angle (illustrated as α_{400K} in FIG. 4A), which can be approximately equal to average of an angle αᵤₚₚₑᵣ of the after upper surface e 402a and an angle α_{lower} of the lower surface 403a with respect to the forward centerline C_{F400} and forward upper and lower surfaces 402f, 403f for the case of a constant cross-section forward fuselage 401, as shown in FIG. 4B (hence, FIG. 4B indicating the upper and lower surfaces 402a, 403a defining the respective upper and lower angles αᵤₚₚₑᵣ, α_{lower}). In some instances, the angles αᵤₚₚₑᵣ, α_{lower} of the aft upper and lower surfaces 402a, 403a vary with respect to the angle of the aft centerline C_{A400}, with the location of a substantial upward deflection in the overall centerline (e.g., kink 431) being defined by the overall shape and slope of the aft fuselage with respect to the forward fuselage (or more generally the overall shape and slope of the aft end 440 with respect to the forward end 420). For example, for the aircraft 100 of FIG. 1B, the lower surface defines a lower angle α_{lower}, which is approximately equal to the tailstrike angle of approximately 12 degrees, and the upper surface angle αᵤₚₚₑᵣ in the aft fuselage is approximately between 6 and 7 degrees. In some exemplary embodiments, the result kink angle of the aft centerline C_{A400} can be approximately in the range of about 0.5 degrees to about 25 degrees, and in some instance it is about 10 degrees with respect to a longitudinal-lateral plane of the cargo aircraft 100, i.e., a plane in which the forward centerline C_{F400} is disposed, the plane extend substantially parallel to the ground or a ground plane P_{400G}. Further, the kink angle α_{400K} can be approximately equal to a degree of maximal rotation of the aircraft during the takeoff operation. Still further, a length of the aft end 140, i.e., the portion that is angled with respect to the forward centerline C_{F400}, can be approximately in the range of about 15% to 65%, and in some instances about 35% to about 50% of a length of the entire fuselage 101, and in some embodiments it can be about 49% the length of the fuselage 101.

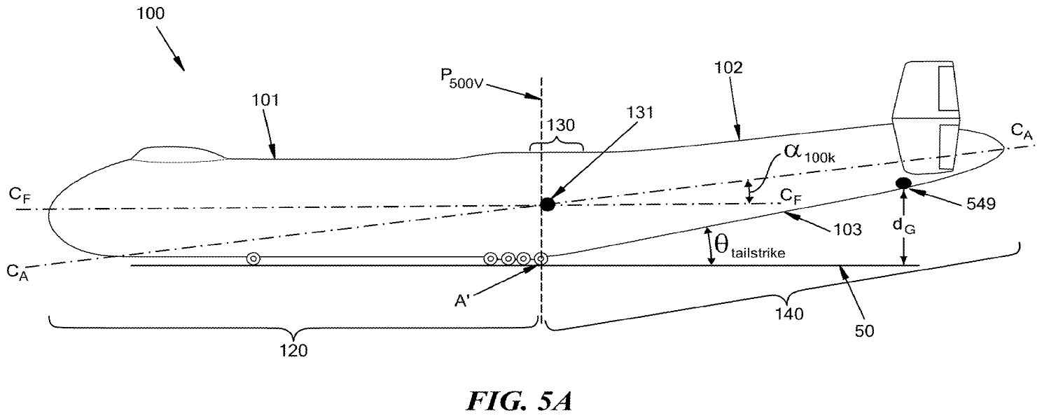

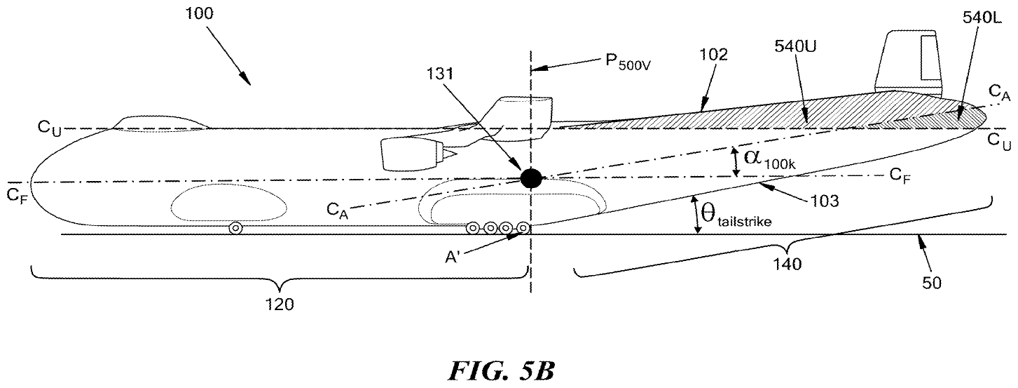

In FIG. 4C, the cargo aircraft 400 is shown on the ground 50 and rotated about the lateral axis of rotation to illustrate, for example, a takeoff pitch-up maneuver. In FIG. 4C, a resting plane P_{400R} of the forward end 420 angled with respect to the ground or ground plane P_{400G} at a degree just before θₜₐᵢₗₛₜᵣᵢₖₑ, as no part of the aft end 440, empennage 450, or tail 442 is contacting the ground. In this position, the lower surface 403a (and, approximately, the aft centerline C_{A400}) is substantially parallel with the ground or ground plane P_{400G}, and it can be seen that because the location of the centerline kink 431 of the kinked portion 430 is approximately with, or very close to, the lateral axis of rotation A′, the angle α_{400K} of the kink 431 is approximately the maximum safe angle of rotation of the aircraft 400 about the lateral axis of rotation A′. FIG. 4C shows a vertical axis 409a aligned with the location of the lateral axis of rotation A′ and another vertical axis 409b aligned with the kink 431 in the fuselage centerline C_{F400}, with a distance d′ therebetween. With d′ being small, and the lower surface 403a of the aft end 440 extending aft with approximately the kink angle α_{400K} of the kink 431 or a slightly larger angle, as shown, the aft end 440 is highly elongated without risking a tail strike. Accordingly, minimizing d′ approximately sets the lower angle α_{lower} as an upper limit to the safe angle of rotation about the lateral pitch axis. Moreover, the upward sweep of the upper surface 402a can be arranged to maintain a relatively large cross-sectional area along most of the aft end 440, thereby enabling a substantial increase in the overall length of the cargo aircraft 400, and thus usable interior cargo bay within the aft end 440, without increasing θₜₐᵢₗₛₜᵣᵢₖₑ. FIG. 5A shows this in further detail for the cargo aircraft 100 of FIG. 1A.

In FIG. 5A, the aft centerline C_{A} and forward centerline C_{F} of the fuselage 101 are shown intersecting at a kink location 131 just aft of the vertical plane P_{500V} of the lateral axis of rotation A′, which occurs within the kinked portion 130 connecting the forward end or fuselage 120 to the aft end or fuselage 140. The lower surface 103 of the aft fuselage 140 approximately defines θₜₐᵢₗₛₜᵣᵢₖₑ of the cargo aircraft 100, which is slightly larger than a kink angle α_{100K} defined by the upslope of the aft centerline C_{A} with respect to the forward centerline C_{F}. Additionally, in some examples, the aft fuselage can include a sensor 549 configured to measure the distance d_{G} of the lower surface 103 of the aft fuselage 140 to the ground 50 to assist the pilot and/or computer in control of the aircraft 100 in maximally rotating the aircraft 100 about the lateral pitch axis without tailstrike.

As explained in more detail below, vertically aligning the kink location 131 with the lateral pitch axis can enable the aft fuselage 140 to extend without decreasing θₜₐᵢₗₛₜᵣᵢₖₑ, which also can enable the useable portion of the interior cargo bay 170 to extend aft along a substantial portion of the aft fuselage 140. Further, the present designs can enable the creation of extremely long aircraft designs capable of executing takeoff and landing operations with shorter runway lengths than previously possible. These lengths can be the equivalent of existing typical runway lengths, or even shorter, which is surprising for an airplane that is longer. Runway lengths approximately in the range of about 500 meters to about 1000 meters are likely possibly in view of the present disclosures, as compared to existing runways, which are about 2000 meters for standard aircraft and about 3000 meters for larger aircrafts. Thus, the engineering related to the aircraft 100, 400, and other embodiments of aircraft derivable from the present disclosures, enable extremely large aircraft that can be used on runways that are the smaller than runways for aircraft that are considered to be large aircraft due, at least in part, to the designs enabling increased pitch angles without causing tailstrike.

A further advantage provided by the present designs is being able to maintain the location of the center-of-gravity of the aircraft close to the lateral pitch axis, which minimizes the downforce required by the tail to rotate the aircraft during takeoff. This minimization of necessary downforce allows pitch-up maneuvers to occur at slower speeds, thereby increasing the available angle of attack (and thus lift) able to be generated at a given speed, which in turn reduces the speed necessary to generate enough lift to get the aircraft off the ground. This advantage is not achievable in prior art designs that attempt to increase their cargo length efficiency (e.g., maximum linear payload length as a function of overall fuselage length) at least because: (1) a reduction in tailstrike angle as the aft fuselage is elongated aft of the lateral rotation axis (e.g., in designs with an aft fuselage bend location being a substantial distance from their lateral axis of rotation); (2) a reduced ability to complete a pitch-up maneuver at low-speeds if the lateral pitch axis is moved aft of the center-of-gravity of the aircraft to accommodate the elongated fuselage, necessitating a substantial increase in wing and/or tail size to achieve the takeoff lengths equal to aircraft designs having lateral pitch axis closer to their center-of-gravity; and/or (3) a reduction in the cargo bay diameter as the aft end of the cargo bay is extended further toward the tail.

FIG. 5B shows the vertical extension of the aft fuselage 140 above the forward portion 120 of the fuselage 101. In FIG. 5B, a line Cᵤ is drawn showing the approximately horizontal extension of the upper surface of the forward portion 120 of the fuselage 101. A substantial portion of the aft portion 140 of the fuselage extends above this line Cᵤ. This includes an upper portion 540U of the aft portion 140 that is above both the line Cᵤ and the aft centerline C_{A} and a lower portion 540L that is above the both the line Cᵤ and below the aft centerline C_{A}. The size of the upper and lower portions 540U, 540L depends on the kink angle α_{100K}, the length of the aft portion 140, and one or both of the upper and lower angles αᵤₚₚₑᵣ, αlower, as these together define the kink angle α_{100K} and the height of the of the aft portion 140 as it extends to the aft end. In some examples, a substantial portion of both the upper and lower portions 540U, 540L is occupied by a portion of the interior cargo bay 170.

FIG. 6A is side cross-section view of the cargo aircraft 100, the cross-section being taken along an approximate midline T-T of the top-most outer surface, as shown in FIG. 1A. The cargo bay 170 defines a centerline that extends along the overall length of the cargo bay 170. The cargo bay 170 extends from a forward end 171 of a forward end or region 170f of the cargo bay 170, as shown located in the nose cone 126, to an aft end 173 of an aft end or region 170a of the cargo bay 170, as shown located in the fuselage tail cone 142. The forward and aft regions 170f, 170a of the cargo bay 170 sit within the forward and aft ends 120, 140, respectively, of the aircraft 100. More particularly, the forward region 170f can generally define a forward cargo centerline C_{FCB} that can be substantially colinear or parallel to the forward fuselage centerline C_{F} (shown in FIG. 5A) and the aft region 170a can generally define an aft cargo centerline C_{ACB} that can be substantially colinear or parallel to the aft fuselage centerline C_{A} (shown in FIG. 5A). Accordingly, in the kinked portion 130 of the fuselage 101, which itself can include a comparable kinked portion 170k of the cargo bay 170, where the aft fuselage centerline C_{A} bends with respect to the forward fuselage centerline C_{F}, the aft cargo centerline C_{ACB} also bends at a kink location 631 with respect to the forward cargo centerline C_{FCB}. The bend can be at approximately the same angle, as shown an angle α_{100KP}, as the kink angle α_{100K} of the fuselage 101. The aft cargo centerline C_{ACB} can extend at least approximately 25% of a length of a centerline of the continuous interior cargo bay 170, i.e., the length of the centerline throughout the entire cargo bay 170. This amount more generally can be approximately in the range of about 25% to about 50%. There are other ways to describe these dimensional relationships as well, including, by way of non-limiting example, a length of the aft cargo centerline C_{ACB} being at least approximately 45% of the length of the fuselage 101 and/or at least approximately 80% of a length of the fuselage 101 aft of the lateral pitch axis, among other relationships provided for herein or otherwise derivable from the present disclosures.

FIG. 6A shows the aft region 170a of the cargo bay 170 extending through almost all of the aft fuselage 140, which is a distinct advantage of the configurations discussed herein. Moreover, due to the length of the aft fuselage 140, a pitch 674 of structural frames 104a of the aft fuselage 140 can be angled with respect to a pitch 672 of structural frames 104f of the forward fuselage 120 approximately equal to the kink angle α_{100K} of the fuselage 101. In some examples, the kinked region 130 represents an upward transition between the pitch 672 of the structural frames 104f of the forward fuselage 120 and the pitch 674 of the structural frames 104a of the aft fuselage 140. A person skilled in the art will recognize that structural frames 104a, 104f are merely one example of structural features or elements that can be incorporated into the fuselage 101 to provide support. Such elements can be more generally described as circumferentially-disposed structural elements that are oriented orthogonally along the aft centerline C_{ACB} and the forward centerline C_{FCB}. In some examples, the location of the cargo bay kink 631 (FIG. 6A) is forward or aft of the fuselage kink 131 (FIG. 5A) such that either the forward cargo region 170f partially extends into the aft fuselage 140 or the aft cargo region 170a partially extends into the forward fuselage 120, however, this generally depends, at least in part, on the distance between the interior of the cargo bay 170 and the exterior of the fuselage, which is typically a small distance for cargo aircraft having a maximally sized cargo bay. Regardless, to fully utilize examples of the present disclosure, the aft region 170a of the cargo bay 170 can be both (1) able to be substantially extended due to the ability of the aft fuselage 140 length to be extended and (2) able to extend along substantially all of the length of the aft fuselage 140 because examples of the present disclosure enable aircraft to have elongated aft fuselages for a fixed tailstrike angle and/or minimized kink angle. Additionally, minimizing the fuselage kink angle for elongated aft fuselages allows the aft region of the cargo bay to extend further along the fuse fuselage while increasing the maximum straight-line payload length for a given overall aircraft length and tailstrike angle, as shown at least in FIGS. 6B and 6C.

FIG. 6B shows a side cross-sectional view of the fuselage 101 of the cargo aircraft 100 of FIG. 6A with a highly elongated payload 10 of two wind turbine blades 11A, 11B disposed substantially throughout the interior cargo bay 170 and extending from the forward end 171 of the forward region 170f to the aft end 173 of the aft region 170a. Having at least a portion of the aft region 170a being linearly connected to (e.g., within line of sight) of at least a portion of the forward region 170f enables the extension of the aft region 170a to result in an extension in the maximum overall length of a rigid payload capable of being carried inside the interior cargo bay 170. Wind turbine blades, however, are often able to be deflected slightly during transport and so examples of the present disclosure are especially suited to their transport as the ability to slightly deflect the payload 10 during transport enables even long maximum payload lengths to be achieved by further extending the aft end 173 of the aft region 170a beyond the line of sight of the forward-most end 171 of the forward region 170f.

FIG. 6C is the same cross-sectional view of the fuselage 101 of the cargo aircraft 100 of FIG. 6B with a maximum length rigid payload 90 secured in the cargo bay 170. A forward end 90f of the maximum length rigid payload 90 can be secured to the cantilevered tongue 160 in the forward end 171 of the forward region 170f with a first portion of the weight of the payload 90 (shown as vector 91A) being carried by the cantilevered tongue 160 and an aft end 90a of the maximum length rigid payload 90 can be secured to the aft end 173 of the aft region 170a with a second portion of the weight of the payload 90 (shown as vector 91B) being carried by the aft end 173 of the aft region 170a.

FIG. 6D is the same cross-sectional view of the fuselage 101 of the cargo aircraft 100 of FIG. 6A with a maximum weight payload 92 secured in the cargo bay 170. A forward end 92f of the maximum weight payload 92 can be secured in the forward region 170f of the interior cargo bay 170 with a first portion of the weight of the payload 92 (shown as vector 93A) being carried by the forward fuselage 120 and an aft end 92a of the maximum weight payload 92 can be secured in the aft region 170a of the interior cargo bay 170 with a second portion of the weight of the payload 92 (shown as vector 93B) being carried by the aft fuselage 140. Advantageously, the substantial length of the cargo bay 170 forward and aft of the a center-of-gravity of the aircraft 100 (e.g., approximately aligned with the kinked region 130) enables positioning of the maximum weight payload 92 such that the payload center-of-gravity (shown as vector 94) substantially close (i.e., within about 30% of wing Mean Aerodynamic Cord (MAC) or about 4% of total aircraft length) to or aligned with the center-of-gravity of the aircraft 100. In some examples, at least about 10% of the weight of maximum weight payload 92 is carried in the aft region 170a. In some examples of carrying a maximum weight payload, especially payloads approaching a maximum length, about 40% to about 50% could be carried in the aft region 170a in order to center the payload's center of gravity at a nominal location in the cargo bay 170.

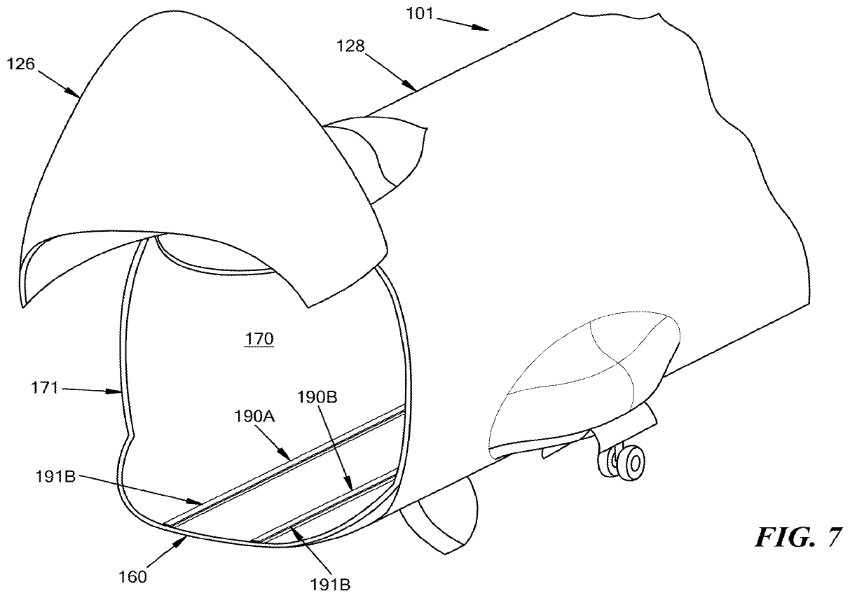

FIG. 7 is a perspective view of the cargo aircraft 100 of FIG. 6A showing a lower support system 190A, 190B that extends along the cargo bay 170 from a forward entrance 171 to and through the aft section 170a (not visible) of the cargo bay 170 in the aft portion 140 (not visible) of the fuselage 101. The lower support system 190A, 190B can include forward portions 191A, 191B that extend forward along the cantilevered tongue 160 as well. In some examples, the lower support system 190A, 190B includes rails or tracks, or similar linear translation components, that enable a payload to be translated into the cargo bay 170 and all the way to the aft end of the aft region 170a of the cargo bay 170 from the cargo opening 171, for instance by having the lower support system 190A, 190B extend through nearly an entire length of the fixed portion 128 of the fuselage 101. In some examples, the lower support system 190A, 190B can be used to support and/or the payload during flight such that the lower support system 190A, 190B can hold substantially all of the weight of the payload.

Additional details about tooling for cargo management, including rails and payload-receiving fixtures and fuselage configuration for enabling loading and unloading of payloads into aft regions of a continuous interior cargo bay are provided in International Patent Application No. PCT/US2020/049784, entitled “SYSTEMS AND METHODS FOR LOADING AND UNLOADING A CARGO AIRCRAFT,” and filed Sep. 8, 2020, and the content of which is incorporated by reference herein in its entirety.

### Kinked Fuselage—Structural Transition Zone

In contrast to previous solutions that utilize a complex single wedge frame to connect two constant-section semi-monocoque fuselage structures together, and thereby drive all the complexity into that single wedge frame to keep complexity out of the two adjoining fuselage structures, examples of the present disclosure enable complex fuselage changes (e.g., the forward-to-aft kink or bend angle in the fuselage and interior cargo bay centerline) to over multiple transverse frames and longitudinally continuous skin panels. The examples of the present disclosure thus reduce the overall structural complexity transition zone between more simply shaped forward and aft fuselage sections.

Examples of the present disclosure provide for an entire semi-monocoque kinked transition section that can be constructed from multiple transverse frames, multiple skin panel segments, and stringers, with compound curvature skins to bridge the gap between two fuselage sections with different frame angles. Examples of the presently described transition section can be “plugged” in between forward and aft fuselage sections and can therefore be connected to a forward fuselage portion via a standard transverse frame (e.g., a ring frame that circumscribes the fuselage), and can likewise be connected to an aft fuselage portion via a different, but similarly standard, transverse frame oriented at an angle to accommodate the overall bend in the fuselage that occurs across the transition zone (i.e., the kinked portion of the fuselage that extends longitudinally between the transverse frame at the aft end of the forward portion and the transverse frame at the forward end of the aft portion), where most or all of the transverse frame sections of the forward portion are aligned in parallel and, similarly, most or all of the transverse frame sections of the aft portion are also aligned in parallel to each other and also at an angle (e.g., the bend angle) with respect to the transverse frame sections of the forward portion. However, examples of the present disclosure include transition sections that can be a unitary structure with forward and aft fuselage sections, such that the end frames of the forward and aft fuselage sections are also beginning frames of the transition section, or, alternatively one or more of the forward and aft fuselage sections and the transition section can be constructed as entire sub-segments that are joined together during a final assembly of the entire fuselage. The change in fuselage angle between the forward and aft transverse frames within the transition zone can occur over longitudinally continuous skin panels to reduce complexity of the angle change joint. In other words, aspects of the present disclosure can reduce the complexity of each single fuselage joint and frame compared with solutions where the fuselage bend occurs across any one single frame. Accordingly, examples of the present disclosure can instead add more complexity to the skin panels by extending the fuselage bend across two or more transverse frame sections, with curved, bent, and/or tapered longitudinal panels and/or frame stringers extending therebetween.

Additional details about the fuselage transition region are provided in International Patent Application No. PCT/US21/21792, entitled “AIRCRAFT FUSELAGE CONFIGURATIONS FOR UPWARD DEFLECTION OF AFT FUSELAGE,” and filed Mar. 10, 2021, and the content of which is incorporated by reference herein in its entirety.

### Upper Cutout Structure Including Box Beam Longerons

As the size of a large cargo aircraft grows, so too does the fuselage wing cutout. Because of this, for the example aircraft 100 of FIG. 1A, both the longitudinal and lateral distances of the cutout are larger than any other aircraft in history and as such the failure modes of the structure along the edges of the cutout are different than previous smaller aircraft which have similar wing position and attachment schemes. The failure modes for the aircraft of the disclosed design are driven more by stability (e.g., buckling) and local beam torsion than that of smaller aircraft with smaller cutouts. For that reason a closed box section was designed to stiffen the cutout. Examples of the present disclosure include upper-wing fuselage cutout designs with perimeter beams of closed cross section. The upper fuselage cutout can be, for example, approximately 9 meters wide (wing span dimension) by 6 meters (length dimension of fuselage). The box beams themselves can range, for example, approximately in the range of about 45 cm to about 90 cm in cross section dimensions, depending on the specific location in the aircraft. Those skilled in the art will appreciate that these dimensions are illustrative examples that depend on a multitude of factors, including, but not limited to, aircraft size, fuselage shape, and aircraft weight.

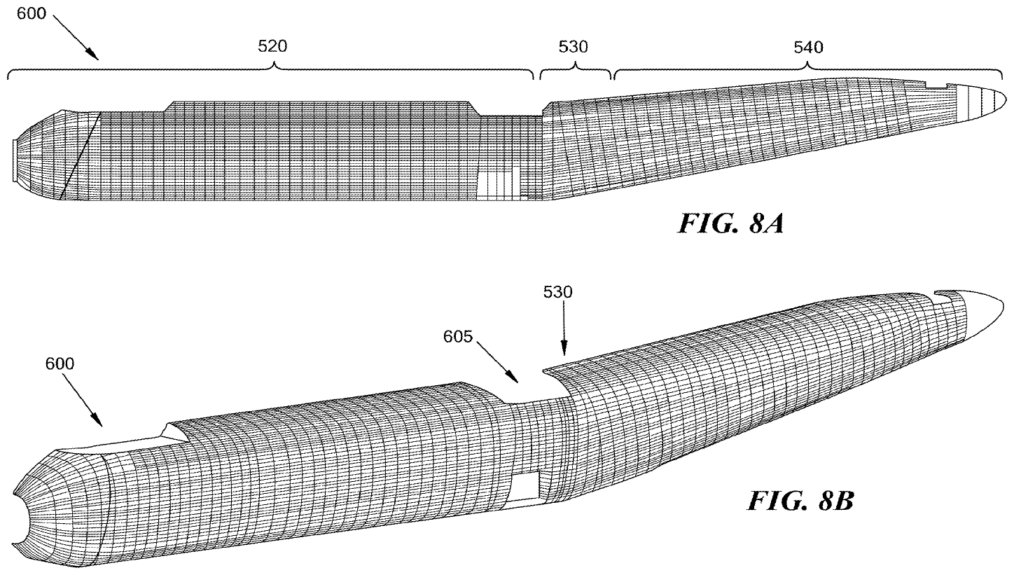

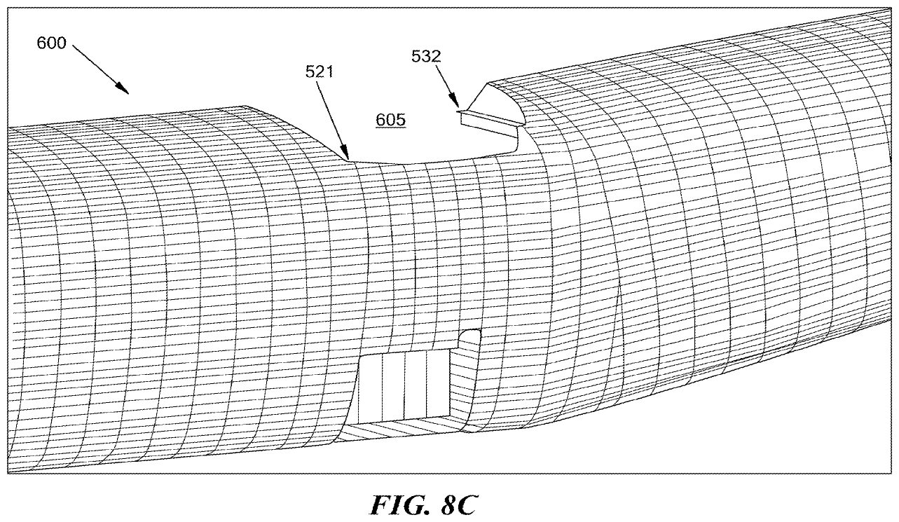

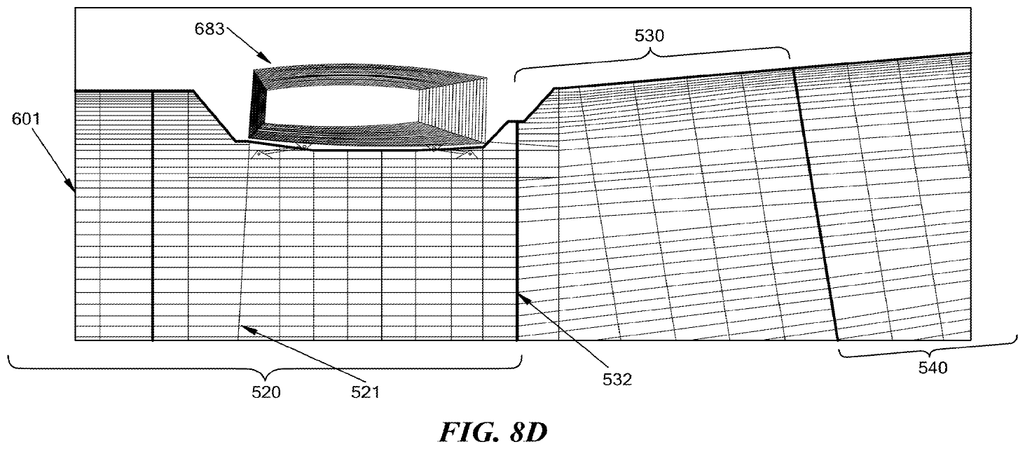

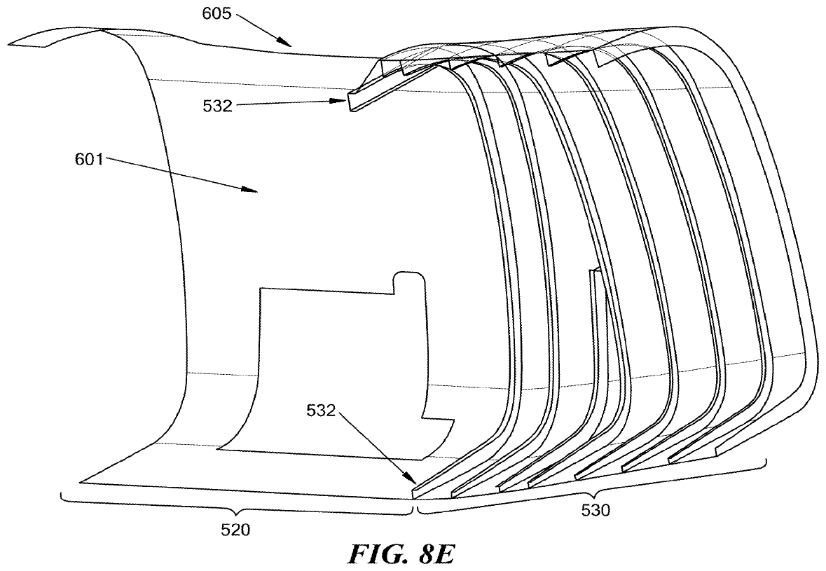

FIGS. 8A and 8B are 3D illustrations of the structural elements 600 of a cargo aircraft fuselage, showing the forward region 520, kinked transition region 530, aft region 540, and upper cutout 605 positioned at the aft end of the forward region 520. FIG. 8C is an isometric detailed view of a lateral half of the kinked portion 530 of the structural elements 600 of the fuselage of FIGS. 8A and 8B. FIG. 8C shows the transverse frame elements 521, 532 that can be positioned forward and aft of the upper cutout 605. The upper cutout 605 can be formed in the aft end of the forward region 520 to permit the wing box, as shown in FIG. 8D, to pass through the fuselage structure where it can be coupled to the structural elements 600 of a cargo aircraft fuselage that are present around the perimeter of the fuselage wing cutout. FIG. 8D is a side view of a partially-skinned exterior of the cargo aircraft fuselage of FIG. 8A showing the kinked transition region 530, and the forward and aft transverse frame elements 521, 532. Specifically, FIG. 8D illustrates the fuselage being a semi-monocoque structure comprised of a skin 601 that can be made from a plurality of panels attached together radially and supported by the transverse frame elements, such as the forward and aft transverse frame elements 521, 532 bordering the upper cutout 605. FIG. 8D shows a wing box 683 being coupled with structural elements of the forward region 520 of the fuselage, such as the forward and aft transverse frame elements 521, 532. In some instances, the aft transverse frame 532 can also be the forward-most frame of the kinked transition region 530.

An isometric view of the aft-end of the forward region 520 and the kinked transition region 530 from a viewpoint inside the fuselage is illustrated in FIG. 8E and shows the aft transverse frame element 532 in more detail, as well as a plurality of transverse frame elements in the kinked transition region 530. The transverse frame elements can have a depth that defines a minimum thickness of the fuselage (e.g., between the skin of the aircraft and the inner volume of the cargo bay 170). One of ordinary skill in the art will appreciate that a number of different transverse frame designs exist, any or all of which may be used to implement aspects of the present disclosure depending on the structural design goals, materials used, loads to be supported, and other aircraft design characterizes. Additionally, as described in more detail below, portions of the transverse frame elements adjacent to the upper cutout 605 can form panels of perimeter box frame beams that further support the perimeter structure of the upper cutout 605 and also can structurally support box beam longerons that span between the forward transverse frame element 521 and the aft transverse frame element 532.

As shown in FIG. 8A, there is a significant cutout in the upper center fuselage. This allows the high wing to partially nest down past the upper fuselage outer mold line (OML) to reduce its drag impact. This layout also allows the wing-fuse attach fittings to spread further apart in the Y-direction (e.g., better reacting global moments about the X-axis) and shortens the vertical distance needed for those fittings. With a large cutout at the top of the fuselage where the global fuse bending moments are the largest, structural supports are provided to strengthen and stiffen the edges of that cutout.

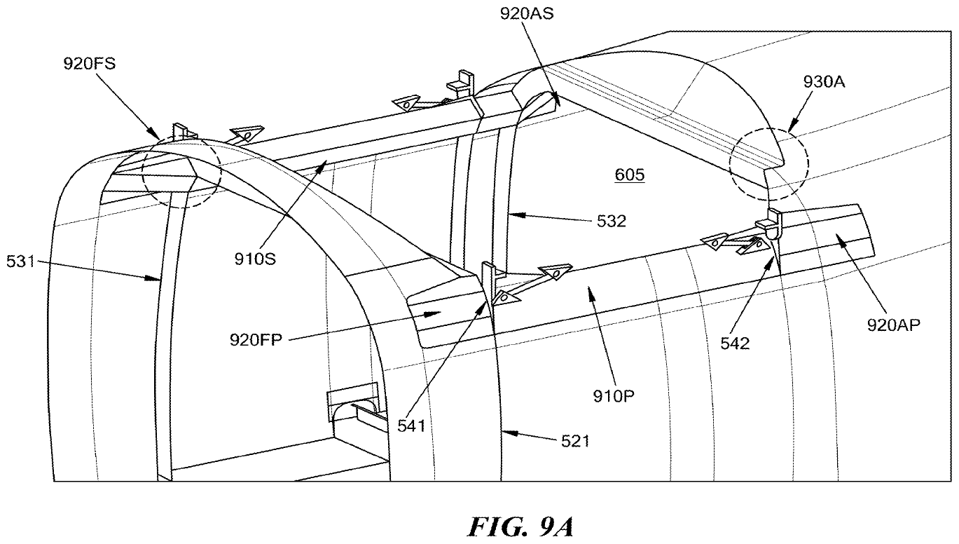

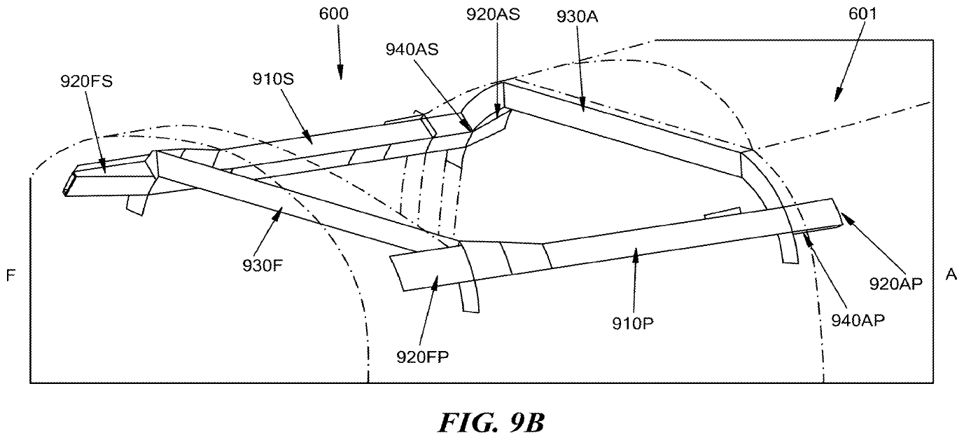

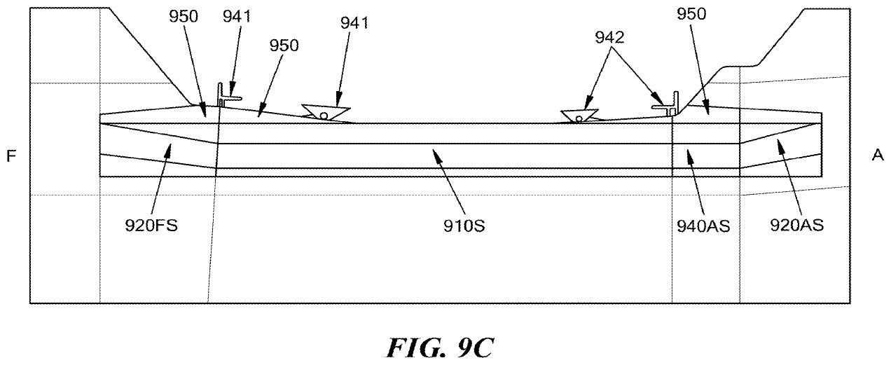

Examples of the present disclosure include using closed section beams to support the forward and aft edges of the upper-wing cutout 605. FIGS. 9A-11C illustrate various aspects of the present disclosure and the use of box beam support members, including longerons and frame beams, to form a perimeter support structure around an upper fuselage cutout 605. The box beam construction examples of FIGS. 9A-11C can be used, for example, with the aircraft 100 of FIGS. 1A-8E to strengthen the fuselage 101 where the upper wing 180 is connected. Referring to FIGS. 8C-8E, in some examples, transverse frame elements 521, 532 can be kinked near the top corners of the fuselage and can be extruded in the Y-direction to form a straight support for the fuselage skin panels forward and aft of the fuselage wing cutout. Longitudinal (X-direction) box-beam longerons can support the left and right edges of the fuselage wing cutout. These longerons can each be built up, for example, from 15 unique panel (as shown, for example, in FIG. 9C). The panels can be fastened together at their corners, for example, using longitudinal “L” cross-section straps. The large section height in both local beam axis can allow the box beams to provide adequate support to the free edges on either side of the wing-cutout. Furthermore, the closed torque box can provide the box beams with more flexural/torsional stability when compared to a more standard “I” or “Z” cross section.

Examples of the present design layout can also allow the wing to fuselage attach fittings to spread further apart in the Y-direction (e.g., better reacting global moments about the X-axis) and shorten the vertical distance needed for those fittings.

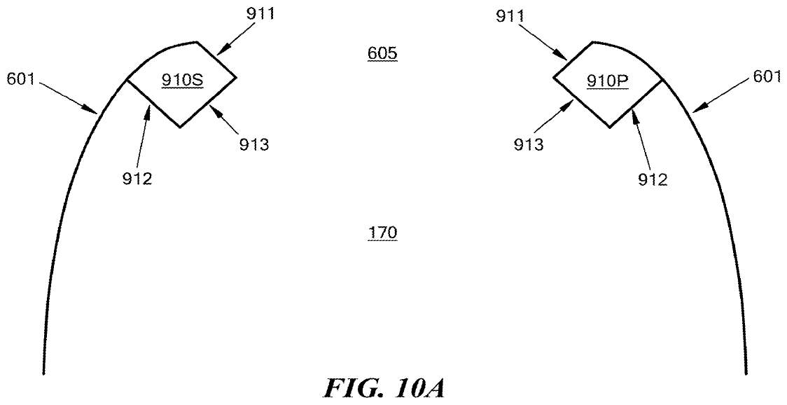

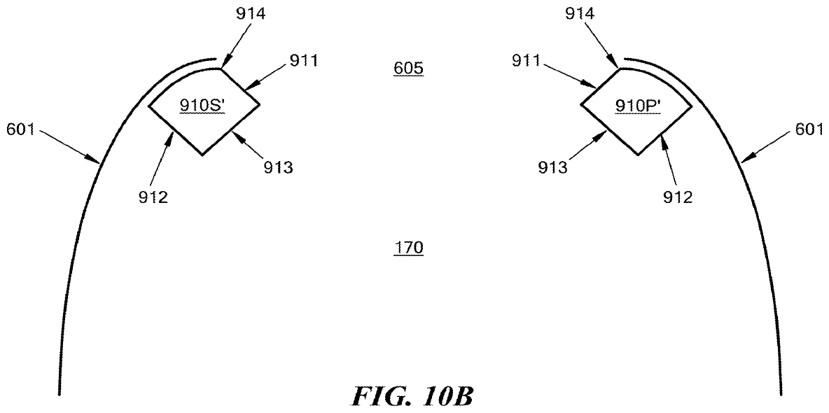

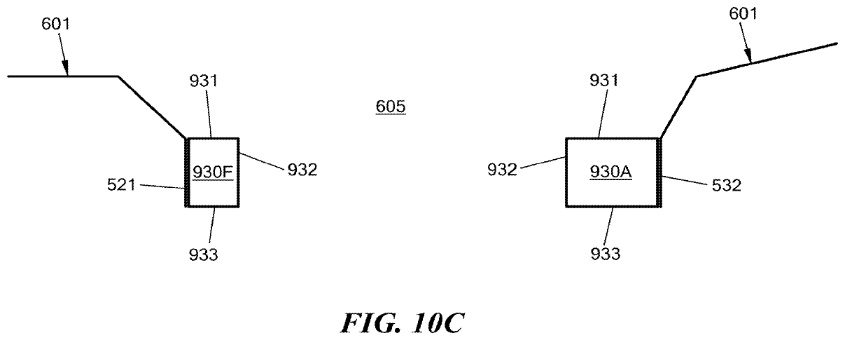

FIG. 9A is an isometric view of a center fuselage section showing an upper-wing cutout incorporating perimeter box beams. The upper cutout 605 is bordered by a port box beam longeron 910P and a starboard box beam longeron 910S. The box beam longerons extend between, and can be structurally integrated with, a forward transverse frame element 521 and an aft transverse frame element 532 that can bookend the upper cutout 605. The box beam longerons can extend forward and aft of the respective transverse frame elements 521, 532 and can terminate with transition regions 920FP, 920FS, 920AP, 920AS, which can reduce the inward-thickness of the box beam longeron towards the fuselage skin 601. In some examples, the box beam longerons can be formed using the exterior fuselage skin panels as one portion of the enclosed box beam construction, as shown in more detail in FIG. 10A.

Continuing to refer to FIG. 9A, the box beam longerons 910P, 910S can receive wing loads via forward and aft wing-fuselage fitting assemblies 541, 542 that can extend from flanges coupled with the respective transverse frame elements 521, 532 and/or can be coupled with the box beam longerons 910P, 910S to secure the wing box 683 to the fuselage 600. In either arrangement, the box beam longerons 910P, 910S can brace the forward and aft transverse frame elements 521, 532, which can enable larger forces and moments to be transferred from the wing box 683 to the fuselage 600 and/or a larger upper cutout 605 to be implemented. Additionally, the structural strength of the box beam construction can reduce the need to add additional structural elements to brace that cutout 605 that could negatively impact the cross-sectional area of the interior cargo volume 170 as it passes the fuselage wing cutout 605.

Referring to FIGS. 9A and 9B, the upper cutout 605 can also have box beam structural elements forming the laterally-extending perimeter of the cutout 605. FIG. 9B is an isometric view of the center fuselage section of FIG. 9A showing the perimeter box beams in solid presentation with the rest of the fuselage in wireframe. FIG. 9B shows a forward box beam frame element 930F extending between the port and starboard box beam longerons 910P, 910S forward of the cutout 605 and an aft box beam frame element 930A extending between the port and starboard box beam longerons 910P, 910S aft of the cutout 605. In some examples, the box beam frame elements 930A, 930F can be formed as an enclosed box from multiple panels, including a web (e.g., inwardly extending panel portion) of the respective forward and aft transverse frame element 521, 532, as shown in more detail in FIG. 10C. Additionally, the box beam longerons and box beam frame elements can intersect and form enclosed box intersections 940AS, 940AP.

FIG. 9C is a cross-section side view of the inner surface of the center fuselage section of FIG. 9A showing the individual panels of the starboard perimeter box beam longeron 910S, as well as the forward and aft mounting hardware 941, 942 of the forward and aft starboard wing-fuselage fittings 541, 542. Three panels and the skin 601 of the fuselage 600 make up each of the starboard box beam longeron 910S, starboard enclosed box intersection 940AS, and the forward and aft starboard transition regions, 920FS, 920AS. Additionally, foot flange panels 950 on the OML can be present to accommodate the forward and aft starboard wing-fuselage fittings 541, 542 that extend out of the OML.

FIG. 10A is a cross section schematic of an example of port and starboard box beam longerons 910S, 910P forming a longitudinal perimeter of the upper cutout 605 above a central section of the interior cargo bay 170. Each box beam longeron 910S, 910P can be constructed from a portion of the skin panel 601 of the fuselage and two inwardly-extending panels (e.g., an upper panel 911 and a lower panel 912) that extend from the skin panel 601 and can be enclosed by an inner panel 913 extending between the upper panel 911 and the lower panel 912 to form a longitudinally-extending box beam along the perimeter of the upper cutout 605. FIG. 10B is a cross section schematic of an alternate example of port and starboard box beam longerons 910S′, 910P′ forming an upper cutout, the port and starboard box beam longerons 910S′, 910P′ having a box construction formed using an additional inner skin panel 914 to close the box structure against the fuselage skin 601. Such a configuration may be used, for example, where additional skin thickness is needed and/or construction of the box beam longeron is done as a separate subassembly to be integrated into the fuselage skin 601. Accordingly, the additional inner skin panel 914 can be riveted or otherwise structurally integrated into the fuselage 600 or be decoupled into one or more locations in order to permit bending of the box beam longeron 910S′, 910P′ without stressing certain locations of the fuselage skin 601 without comprising the strength of the box beam longeron across the fuselage wing cutout.

FIG. 10C is a cross section schematic of an example of forward and aft box beam frame elements 930F, 930A forming the lateral perimeter of an upper cutout 605. The beam frame elements 930F, 930A can be formed against a web section of the respective forward and aft transverse frame element 521, 532 such that the web of the transverse frame element that extends inwardly away from the fuselage skin 601 can form a portion of the enclosed box beam structure of the respective beam frame element. Additionally, an upper panel 931 and a lower panel 933 can extend from the web of the transverse frame element 521 and can be enclosed by an inner panel 932 to form the box beam along the lateral perimeter of the cutout 605. FIG. 10C shows both the forward and aft transverse frame elements forming box beam elements 930F, 930A, however, in some examples, only one of the forward and aft transverse frame elements 521, 532 form perimeter box beams. Additionally, while FIG. 10C shows both the forward and aft transverse frame element forming the out panel (with respect to the cutout 605) of the box beam, the transverse frame element may alternatively form the inner panel 932. Also, in some examples, the upper panel 931 and/or the lower panel 933 can be monolithic flanges of the transverse frame element such that the transverse frame element has an “L-shape,” “C-shape,” or “T-shape” profile.

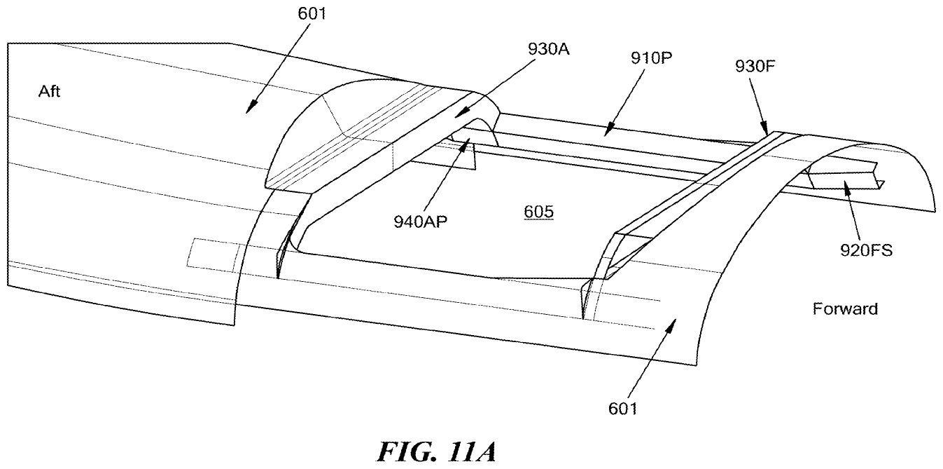

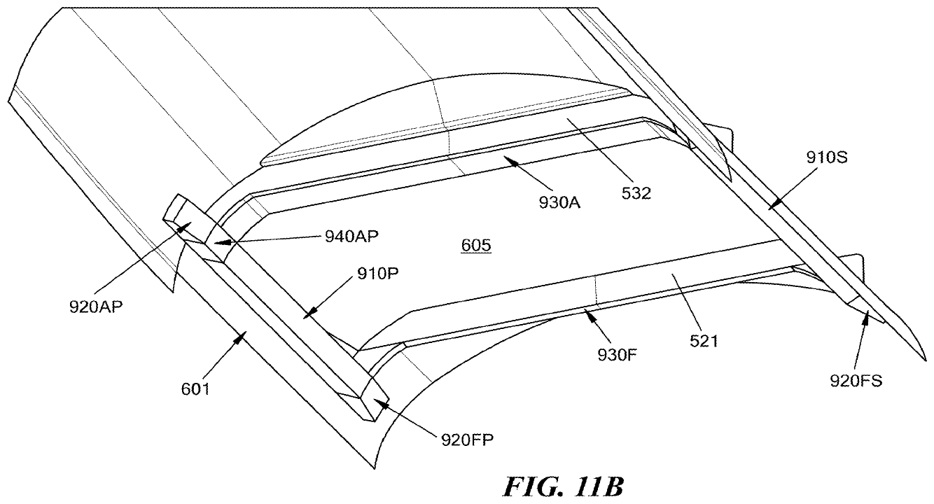

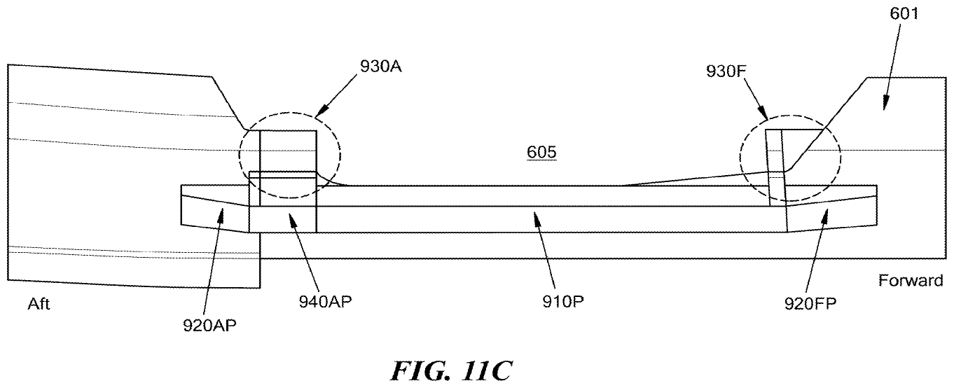

FIGS. 11A-C illustrate further details of example perimeter box beam construction of an upper fuselage cutout 605. FIG. 11A-C show solid model views of only an upper region of the central fuselage portion, with FIG. 11A illustrating an isometric view from outside the upper fuselage looking down, FIG. 11B illustrating an isometric view from outside the upper fuselage looking up, and FIG. 11C illustrating a side-view of the fuselage cutout 605 from inside the fuselage. FIG. 11A shows the port box beam longeron 910P and the starboard box beam longeron 910S extending between the forward and aft box beam frame elements 930F, 930A, with the forward starboard transition region 920F extending forward past the forward box beam frame element 930F and the port box beam longeron 910P defining a closed box interface region (e.g., an enclosed box intersection 940AP) where the port box beam longeron 910P can exted through the aft box beam frame elements 930A. As shown in FIG. 11B, the forward frame element 930F may have a reduced longitudinal thickness as compared with the aft box beam frame elements 930A, and either of the forward and aft box beam frame elements 930F, 930A can be constructed from a more traditional frame-shape, such as an I-shape, as well as a solid-beam construction. FIG. 11C shows the entire length of the port box beam longeron 910P, extending from the aft transition region 920AP to the forward transition region 920FP, passing through the forward and aft box beam frame elements 930F, 930A. Regardless of the shape of the forward and aft box beam frame elements 930F, 930A, the port box beam longeron 910P (and the starboard) can extend to and beyond the forward and aft box beam frame elements 930F, 930A, with or without a box construction interface region (e.g., enclosed box intersection 940AP) and can, in some examples, terminate with a transition region 920AP that reduces the inward-thickness of the box beam longeron towards the fuselage skin 601.

One skilled in the art will appreciate that other termination configuration as possible and can depend, at least in part, on the shape of the fuselage skin 601 and the transverse frame elements, among other factors. For example, the port box beam longeron 910P can extend to and beyond the aft box beam frame elements 930A and can terminate at any of the next transverse frame elements (as shown in the aft region 530 in FIG. 8E). Additionally, one skilled in the art will appreciate that there are a number of different well-known techniques for coupling the members (e.g., sides) of the box beam longerons 910P, 910A the transition regions, 920FP, 920FS, 920AP, 920AS and/or the box beam frame elements 930F, 930A with the fuselage 101 and/or the fuselage skin 601, for example, welding and riveting. Additionally, any one or more the members (e.g., sides) of the box beam longerons 910P, 910A the transition regions 920FP, 920FS, 920AP, 920AS, and/or the box beam frame elements 930F, 930A can be formed as integral or monolithic components with any one or more components of the fuselage 101 and/or skin 601. And, while the examples illustrated herein show only one box beam longeron 910P, 910A and one box beam frame element 930F, 930A per side of the cutout 605, other configurations are possible, such as two or more box beam longerons/frame elements per side in order to further strengthen the fuselage 101 in the regions immediately adjacent to the box beam longerons 910P, 910A and one box beam frame elements 930F, 930A that form the perimeter.

The box beam longerons shown in FIGS. 9A-11C are shown generally being substantially parallel to the longitudinal axis of the aircraft 100 and the box beam frame elements have central-sections substantially parallel to a lateral axis of the aircraft and ends that curve downward. Nevertheless, other configurations are possible, such as some or all of the box beam longerons and box beam frame elements having curved sections, which may include complex curves, discontinuities (e.g., notches in order to provide clearances), as well as holes in the sides for weight reduction and/or clearance or access. One skilled in the art will appreciate that traditional techniques for sizing and shaping structural members for aircraft fuselages can be applied to the examples presented herein, for example to integrate the box beam construction with an aircraft fuselage.

The box beam longerons and box beam frame elements shown in FIGS. 9A-11C have a four-sided approximately rectangular configuration, but other configurations are possible, such as having five (5) or more sides and/or a non-rectangular shape, such as a trapezoid, parallelogram, and rhombus. Additionally, the box beam longerons can have a curved profile, including rounded and/or circular sections. Additionally, while the examples of FIGS. 9A-11C illustrate an upper cutout, other configurations are possible, such as a lower wing cutout or even a pass-through cutout that opens only on lateral sides of the fuselage. Still further, while the examples of FIGS. 9A-11C illustrate the cutout being configured for a main wing, other configurations are possible, such as for an aft tail or empennage structure and/or any other lifting body or structure extending from the fuselage that may direct forces to and/or from the fuselage. Additionally, while the examples of FIGS. 9A-11C illustrate continuous box beam longerons extending between forward and aft frame elements, it is also possible to have a plurality of additional frame element disposed along the fuselage wing cutout such that their upper shape is formed to the underside of the fuselage wing cutout and the box beam longerons can extend across multiple such frame elements, or any other structural elements present on the inner surface of the fuselage skin adjacent to the fuselage wing cutout. Still further, while the examples of FIGS. 9A-11C illustrate box beam longerons and box beam frame elements having an open interior structure, other configurations are possible, such as having a plurality of internal bracing members. Additionally, while the examples of FIGS. 9A-11C illustrate box beam longerons and box beam frame elements having a generally straight extensions around the perimeter of the fuselage wing cutout, other configurations are possible, such as a twist in the box beam structure as it extends and/or a bend in one or more directions, such as shown in the port and starboard ends of the box beam frame elements that turn downward to meet the port and starboard box beam longerons.

One skilled in the art will appreciate further features and advantages of the disclosures based on the provided for descriptions and embodiments. Accordingly, the inventions are not to be limited by what has been particularly shown and described. For example, although the present disclosure provides for transporting large cargo, such as wind turbines, the present disclosures can also be applied to other types of large cargos or to smaller cargo. All publications and references cited herein are expressly incorporated herein by reference in their entirety.

Examples of the above-described embodiments can include the following:
1. A cargo aircraft, comprising:
   a fuselage defining a forward end, an aft end, and a continuous interior cargo bay that spans a majority of a length of the fuselage from the forward end to the aft end, the fuselage including:
      a fuselage wing cutout defined by a plurality of structural elements configured to transfer a wing load to the fuselage, the structural elements including opposite starboard and port longeron beams each spanning a longitudinal length of the cutout, the starboard and port longeron beams having an enclosed box beam construction.
2. The cargo aircraft of claim 1, wherein the perimeter of structural elements includes forward and aft frame beams each spanning a lateral length of the cutout, at least one of the forward frame beams or the aft frame beams having an enclosed box beam construction.
3. The cargo aircraft of claim 2, wherein both of the forward and aft frame beams have an enclosed box beam construction.
4. The cargo aircraft of claim 2 or 3, wherein the fuselage comprises: (i) a starboard structural interface between the one of the forward and aft frame beams having an enclosed box beam construction and the starboard longeron beam; and (ii) a port structural interface between the one of the forward and aft frame beams having an enclosed box beam construction and the port longeron beam.
5. The cargo aircraft of claim 4, wherein the starboard and port structural interfaces have an enclosed box construction.
6. The cargo aircraft of any of claims 2 to 5, wherein the starboard and port longeron beams and the forward and aft frame beams define an approximately rectangular or trapezoidal opening into the fuselage.
7. The cargo aircraft of any of claims 1 to 6, wherein the continuous interior cargo bay extends along all of the longitudinal length of the cutout.
8. The cargo aircraft of any of claims 1 to 7, wherein the enclosed box beam construction comprises a plurality of panel sections, at least one of the plurality of panel sections comprising a skin panel of the fuselage.
9. The cargo aircraft of any of claims 1 to 8, wherein the enclosed box beam construction comprises a four panel construction including: (1) a skin panel of the fuselage; (2) an upper panel extending inward from the skin panel; (3) a lower panel extending inward from the skin panel; and (4) an inner panel extending from the upper panel to the lower panel.
10. The cargo aircraft of any of claims 1 to 9, wherein the fuselage wing cutout comprises an upper cutout formed as a cutout in a top region of the fuselage.
11. The cargo aircraft of claim 10, wherein the plurality of structural elements are arranged around a perimeter of the upper cutout.
12. The cargo aircraft of any of claims 1 to 11,
   wherein the fuselage further comprises a forward transverse frame section located forward of the fuselage wing cutout and an aft transverse frame section located aft of the fuselage wing cutout, and
   wherein the starboard and port longeron beams each extend at least from the forward transverse frame section to the aft transverse frame section.
13. The cargo aircraft of claim 12, wherein the perimeter of structural elements includes forward and aft frame beams each spanning a lateral length of the cutout, at least one of the forward and aft frame beams having an enclosed box beam construction having a plurality of panel sections, and at least one of the plurality of panel sections comprising a web panel of a respective forward or transverse frame section.
14. The cargo aircraft of claim 12 or 13, the fuselage further comprising:
   a forward portion containing a forward region of the continuous interior cargo bay, the forward portion defining a forward centerline along a longitudinal-lateral plane of the cargo aircraft;
   an aft portion containing an aft region of the continuous interior cargo bay, the aft portion defining an aft centerline extending above the longitudinal-lateral plane of the cargo aircraft; and
   a kinked portion forming a junction in the fuselage between the forward portion and the aft portion of the fuselage and between the forward and aft regions of the continuous interior cargo bay, the kinked portion containing a transition region of the continuous interior cargo bay and defining a bend angle between the forward centerline and the aft centerline,
   wherein the forward transverse frame section is located in the forward portion of the fuselage.
15. The cargo aircraft of any of claims 1 to 14, wherein at least a forward end or an aft end of at least one of the starboard or port longeron beams terminates with a tapered section that defines an enclosed box beam with a cross-section that tapers away from the cutout and along a skin panel of the fuselage.
16. The cargo aircraft of any of claims 1 to 15, further comprising:
   a first fixed wing extending from the fuselage in a first direction away from the fuselage;
   a second fixed wing extending from the fuselage in a second direction away from the fuselage, the second direction approximately symmetric about a longitudinal-vertical center plane of the cargo aircraft; and
   a wing box extending between the first fixed wing and the second fixed wing and along the fuselage wing cutout,
   wherein the wing box is secured to the plurality of structural elements of the fuselage wing cutout.
17. The cargo aircraft of claim 16,
   wherein the fuselage wing cutout comprises an upper cutout formed as a cutout in a top region of the fuselage, and
   wherein cargo aircraft has an upper wing configuration with an upper wing surface extending across the top of the aircraft from the first fixed wing to the second fixed wing.
18. The cargo aircraft of any of claims 1 to 17, wherein the fuselage wing cutout comprises an opening into the continuous interior cargo bay.
19. The cargo aircraft of any of claims 1 to 18, wherein the length of the fuselage is greater than about 84 meters, and wherein the continuous interior cargo bay defines a maximum payload length of at least about 70 meters.
20. A cargo aircraft, comprising:
   a fuselage defining a forward end, an aft end, and a continuous interior cargo bay that spans a majority of a length of the fuselage from the forward end to the aft end, the fuselage including:
      a forward portion containing a forward region of the continuous interior cargo bay, the forward portion defining a forward centerline along a longitudinal-lateral plane of the cargo aircraft;
      an aft portion containing an aft region of the continuous interior cargo bay, the aft portion defining an aft centerline extending above the longitudinal-lateral plane of the cargo aircraft;
      a kinked portion forming a junction in the fuselage between the forward portion and the aft portion of the fuselage and between the forward and aft regions of the continuous interior cargo bay, the kinked portion containing a transition region of the continuous interior cargo bay and defining a bend angle between the forward centerline and the aft centerline; and
      a fuselage wing cutout defined by a plurality of structural elements configured to transfer a wing load to the fuselage, the structural elements including opposite starboard and port longeron beams each spanning a longitudinal length of the cutout, the starboard and port longeron beams having an enclosed box beam construction;
   a first fixed wing extending from the fuselage in a first direction away from the fuselage;
   a second fixed wing extending from the fuselage in a second direction away from the fuselage, the second direction approximately symmetric about a longitudinal-vertical center plane of the cargo aircraft; and
   a wing box connecting the first fixed wing to the second fixed wing and extending along the fuselage wing cutout,
   wherein the wing box is secured to the plurality of structural elements of the fuselage wing cutout.
21. The cargo aircraft of claim 20,
   wherein the fuselage wing cutout comprises an upper cutout formed as a cutout in a top region of the fuselage, and
   wherein the cargo aircraft has an upper wing configuration with an upper wing surface extending across the top of the aircraft from the first fixed wing to the second fixed wing.
22. The cargo aircraft of claim 21, wherein the plurality of structural elements are arranged around a perimeter of the upper cutout.
23. The cargo aircraft of any of claims 20 to 22, wherein the wing box is located forward of the kinked portion.
24. The cargo aircraft of any of claims 20 to 23, wherein the perimeter of structural elements includes forward and aft frame beams each spanning a lateral length of the cutout, at least one of the forward and aft frame beams having an enclosed box beam construction.
25. The cargo aircraft of claim 24, wherein both of the forward and aft frame beams have an enclosed box beam construction.
26. The cargo aircraft of claim 24 or 25, wherein the fuselage comprises: (i) a starboard structural interface between the one of the forward and aft frame beams having an enclosed box beam construction and the starboard longeron beam; and (ii) a port structural interface between the one of the forward and aft frame beams having an enclosed box beam construction and the port longeron beam.
27. The cargo aircraft of claim 26, wherein the starboard and port structural interfaces have an enclosed box construction.
28. The cargo aircraft of claim 26 or 27, wherein the starboard and port longeron beams and the forward and aft frame beams define an approximately rectangular or trapezoidal opening into the fuselage.
29. The cargo aircraft of any of claims 20 to 28, wherein the continuous interior cargo bay extends along all of the longitudinal length of the cutout.
30. The cargo aircraft of any of claims 20 to 29, wherein the enclosed box beam construction comprises a plurality of panel sections, at least one of the plurality of panel sections comprising a skin panel of the fuselage.
31. The cargo aircraft of any of claims 20 to 30, wherein the enclosed box beam construction comprises a four panel construction including: (1) a skin panel of the fuselage; (2) an upper panel extending inward from the skin panel; (3) a lower panel extending inward from the skin panel; and (4) an inner panel extending from the upper panel to the lower panel.

1. A cargo aircraft, comprising:
a fuselage defining a forward end, an aft end, and a continuous interior cargo bay that spans a majority of a length of the fuselage from the forward end to the aft end, the fuselage including:
a wing cutout defined by a plurality of structural elements configured to transfer a wing load to the fuselage, the structural elements including opposite starboard and port longeron beams each spanning a longitudinal length of the cutout, the starboard and port longeron beams having an enclosed box beam construction.

2. The cargo aircraft of claim 1, wherein the perimeter of structural elements includes forward and aft frame beams each spanning a lateral length of the cutout, at least one of the forward frame beams or the aft frame beams having an enclosed box beam construction.

3. The cargo aircraft of claim 2, wherein both of the forward and aft frame beams have an enclosed box beam construction.

4. The cargo aircraft of claim 2, comprising: (i) a starboard structural interface between the one of the forward and aft frame beams having an enclosed box beam construction and the starboard longeron beam; and (ii) a port structural interface between the one of the forward and aft frame beams having an enclosed box beam construction and the port longeron beam.

5. The cargo aircraft of claim 4, wherein the starboard and port structural interfaces have an enclosed box construction.

6. The cargo aircraft of claim 2, wherein the starboard and port longeron beams and the forward and aft frame beams define an approximately rectangular or trapezoidal opening into the fuselage.

7. The cargo aircraft of claim 1, wherein the continuous interior cargo bay extends along all of the longitudinal length of the cutout.

8. The cargo aircraft of claim 1, wherein the enclosed box beam construction comprises a plurality of panel sections, at least one of the plurality of panel sections comprising a skin panel of the fuselage.

9. The cargo aircraft of claim 1, wherein the enclosed box beam construction comprises a four panel construction including: (1) a skin panel of the fuselage; (2) an upper panel extending inward from the skin panel; (3) a lower panel extending inward from the skin panel; and (4) an inner panel extending from the upper panel to the lower panel.

10. The cargo aircraft of claim 1, wherein the wing cutout comprises an upper cutout formed as a cutout in a top region of the fuselage.

11. The cargo aircraft of claim 10, wherein the plurality of structural elements are arranged around a perimeter of the upper cutout.

12. The cargo aircraft of claim 1,
wherein the fuselage further comprises a forward transverse frame section located forward of the wing cutout and an aft transverse frame section located aft of the wing cutout, and
wherein the starboard and port longeron beams each extend at least from the forward transverse frame section to the aft transverse frame section.

13. The cargo aircraft of claim 12, wherein the perimeter of structural elements includes forward and aft frame beams each spanning a lateral length of the cutout, at least one of the forward and aft frame beams having an enclosed box beam construction having a plurality of panel sections, and at least one of the plurality of panel sections comprising a web panel of a respective forward or transverse frame section.

14. The cargo aircraft of claim 12, the fuselage further comprising:
a forward portion containing a forward region of the continuous interior cargo bay, the forward portion defining a forward centerline along a longitudinal-lateral plane of the cargo aircraft;
an aft portion containing an aft region of the continuous interior cargo bay, the aft portion defining an aft centerline extending above the longitudinal-lateral plane of the cargo aircraft; and
a kinked portion forming a junction in the fuselage between the forward portion and the aft portion of the fuselage and between the forward and aft regions of the continuous interior cargo bay, the kinked portion containing a transition region of the continuous interior cargo bay and defining a bend angle between the forward centerline and the aft centerline,
wherein the forward transverse frame section is located in the forward portion of the fuselage.

15. The cargo aircraft of claim 1, wherein at least a forward end or an aft end of at least one of the starboard or port longeron beams terminates with a tapered section that defines an enclosed box beam with a cross-section that tapers away from the cutout and along a skin panel of the fuselage.

16. The cargo aircraft of claim 1, further comprising:
a first fixed wing extending from the fuselage in a first direction away from the fuselage;
a second fixed wing extending from the fuselage in a second direction away from the fuselage, the second direction approximately symmetric about a longitudinal-vertical center plane of the cargo aircraft; and
a wing box extending between the first fixed wing and the second fixed wing and along the wing cutout,
wherein the wing box is secured to the plurality of structural elements of the wing cutout.

17. The cargo aircraft of claim 16, wherein the wing cutout comprises an upper cutout formed as a cutout in a top region of the fuselage, and wherein cargo aircraft has an upper wing configuration with an upper wing surface extending across the top of the aircraft from the first fixed wing to the second fixed wing.

18. The cargo aircraft of claim 1, wherein the wing cutout comprises an opening into the continuous interior cargo bay.

19. The cargo aircraft of claim 1, wherein the length of the fuselage is greater than about 84 meters, and wherein the continuous interior cargo bay defines a maximum payload length of at least about 70 meters.

20. A cargo aircraft, comprising:
a fuselage defining a forward end, an aft end, and a continuous interior cargo bay that spans a majority of a length of the fuselage from the forward end to the aft end, the fuselage including:
a forward portion containing a forward region of the continuous interior cargo bay, the forward portion defining a forward centerline along a longitudinal-lateral plane of the cargo aircraft;
an aft portion containing an aft region of the continuous interior cargo bay, the aft portion defining an aft centerline extending above the longitudinal-lateral plane of the cargo aircraft;
a kinked portion forming a junction in the fuselage between the forward portion and the aft portion of the fuselage and between the forward and aft regions of the continuous interior cargo bay, the kinked portion containing a transition region of the continuous interior cargo bay and defining a bend angle between the forward centerline and the aft centerline; and
a wing cutout defined by a plurality of structural elements configured to transfer a wing load to the fuselage, the structural elements including opposite starboard and port longeron beams each spanning a longitudinal length of the cutout, the starboard and port longeron beams having an enclosed box beam construction;
a first fixed wing extending from the fuselage in a first direction away from the fuselage;
a second fixed wing extending from the fuselage in a second direction away from the fuselage, the second direction approximately symmetric about a longitudinal-vertical center plane of the cargo aircraft; and
a wing box connecting the first fixed wing to the second fixed wing and extending along the wing cutout,
wherein the wing box is secured to the plurality of structural elements of the wing cutout.

21-31. (canceled)
